(19) United States
(12) Patent Application Publication
(10) Pub. No.: US 2011/0040056 A1
(43) Pub. Date: Feb. 17, 2011

(54) PROCESS FOR PRODUCTION OF POLYMER

(76) Inventor: Arimichi Okumura, Hyogo (JP)

Correspondence Address: BIRCH STEWART KOLASCH & BIRCH, PO BOX 747, FALLS CHURCH, VA, 22040-0747, US

(21) Appl. No.: 12/933,038

(22) PCT Filed: Mar. 13, 2009
(86) PCT No.: PCT/JP2009/001125

§ 371 Date: Sep. 16, 2010

(30) Foreign Application Priority Data
Mar. 17, 2008 (JP) 2008-067048

(51) Int. Cl. C08F 124/00

(52) U.S. Cl. 526/266

(57) ABSTRACT

Disclosed is a process for the production of a polymer by polymerizing a monomer or monomers in a solvent to give a polymer solution; and bringing the polymer solution into contact with a poor solvent to precipitate the polymer and to remove impurities therefrom, in which the polymer solution is diluted with a solvent before being brought into contact with the poor solvent to precipitate the polymer. The polymerization solvent preferably has a coefficient of viscosity at 20° C. of 1 mPa·s or more. The dilution solvent preferably has a coefficient of viscosity at 20° C. of less than 1 mPa·s. The process enables efficient production of a polymer with good reproducibility in quality, which polymer contains less amounts of residual monomers and is useful as resist polymers, polymers for undercoat films of multilayer resists, polymers for anti-reflection coatings, and polymers for immersion topcoats.

### TECHNICAL FIELD

The present invention relates to processes for the production of polymers. The produced polymers are useful as polymers for the formation of coated films adopted to semiconductor lithography, such as resist polymers, polymers for anti-reflection coatings, polymers for undercoat films (bottom coats) of multilayer resists, and polymers for immersion topcoats.

### BACKGROUND ART

Recent dramatic innovation on lithography patterning techniques in the manufacture of semiconductors (semiconductor devices) has made lithographic line widths finer and finer. In lithographic exposure, i line and g line were initially used and gave patterns with broad line widths, and the fabricated semiconductor devices thereby had low capacities. However, recent technological development has allowed the use of KrF excimer laser and further recently has allowed the use of ArF excimer laser to give patterns with dramatically finer line widths. In addition, developments for finer and finer patterning have been still actively made. Typically, exposure systems which enable immersion lithography have been developed; and techniques for exposure to extreme-ultraviolet rays (EUV) having shorter wavelengths among ultraviolet rays have also been developed.

In these lithography techniques for the manufacture of semiconductor devices, various coated films are used typically as resist films, and as overcoat films and undercoat films overlying and underlying, respectively, the resist films. The resist films are used for the formation of a resist pattern on a substrate and utilize a phenomenon in which an acid is generated upon irradiation with light, and the acid acts on only exposed portions (irradiated portions) of the resist films to change in solubility in an alkaline developer. Exemplary overcoat films include protective films and topcoat films (topcoats). The protective films protect the resist films from invasion of environmental amines. The topcoat films protect the resist films from the action of an exposure medium during an immersion lithography process which is being developed recently. Exemplary undercoat films include anti-reflection coatings, planarizing films, and bottom resist coats. The anti-reflection coatings suppress reflected light from the substrate to thereby form a fine resist pattern accurately. The planarizing films are used, when a resist pattern is further formed on an already patterned substrate, as a layer underlying the resist, in order to planarize the roughness of the patterned surface of the substrate. The bottom resist coats are used in a multilayer resist for transferring a resist pattern through dry etching. Each of these coated films is formed by dissolving a corresponding polymer for lithography, which has a desired function of the target coated film, as well as other components such as additives, in an organic solvent to give a coating composition; applying the coating composition to the substrate typically through spin coating; and, where necessary, further removing the organic solvent by subjecting the applied film to a treatment such as heating. These polymers for lithography need properties required of such resist films, overcoat films, and undercoat films, including optical properties, chemical properties, and physical properties such as coatability and adhesion to the substrate or undercoat film. In addition, they also need basic properties as polymers for coated films, such as absence of impurities that impede fine patterning.

Many of polymers for topcoats are copolymers prepared by copolymerizing a fluorine-containing monomer with a monomer typically having a carboxylic acid, sulfonic acid, or fluoroalcohol moiety in its side chain, so as to allow the resulting copolymers to have water repellency and developability with an alkaline developer in good balance.

Many of polymers for anti-reflection coatings are copolymers prepared by copolymerizing a monomer having an aromatic group acting as a light-absorbing functional group (e.g., benzene, naphthalene, anthracene, or a derivative thereof) with a monomer having a polar group such as hydroxyl group, carboxyl group, or epoxy group. The monomer having a polar group is used to impart crosslinkability and/or adhesion to the polymers.

Many of resist polymers are copolymers prepared by copolymerizing a monomer having an alicyclic hydrocarbon group (e.g., a group derived from adamantane or tricyclodecane) or an aromatic hydrocarbon group (e.g., a group derived from naphthalen'e) for imparting etching resistance; a monomer having a group capable of leaving with an acid for imparting contrast with respect to an alkaline developer; and a monomer having a lactone structure for imparting adhesion typically to the substrate. Furthermore, with increasing fineness (decreasing line widths) of semiconductor devices, more and more monomers having a halogen atom and/or an aromatic hydrocarbon group in the molecule will be used.

The production of copolymers for use in semiconductor lithography such as resist polymers and polymers for anti-reflection coatings requires a purification step for removing impurities added or formed during the polymerization reaction, such as unreacted monomers, polymerization initiators, chain-transfer agents, and coupling products of them. This is because such impurities, if remaining in the produced polymers, can evaporate during lithography to damage the exposure system and/or can undergo polymerization during storage as copolymers or compositions for lithography and thereby form substances causing pattern defects.

To purify such a copolymer, a known process is a process of bringing the polymerization solution (solution after polymerization) into contact with a poor solvent to reprecipitate the copolymer as solids. When the copolymer is not sufficiently purified through reprecipitation performed only once, it can be subjected to reprecipitation two or more times. This procedure, however, is undesirable from the viewpoint of productivity, because operations such as precipitation, filtration, and redissolution should be performed repeatedly.

Known as simpler processes are processes in which solids obtained through reprecipitation are dispersed in a poor solvent or in a solvent mixture of a poor solvent and a good solvent, followed by rinsing and filtration. Typically, there are disclosed a process in which solids obtained through reprecipitation are dispersed in a poor solvent or in a solvent mixture of a poor solvent and a good solvent, and the dispersion is heated, and solids are collected or separated by filtration; and a process in which solids obtained through reprecipitation are dispersed in a poor solvent, a liquid is removed therefrom with a centrifugal separator, the residue is combined with and rinsed with a small portion of the poor solvent using a centrifugal separator. However, even these processes require repeating of operations such as redispersion and separation by filtration, and it is difficult to remove low-molecular-weight components included in particles of the copolymer by these processes.

Accordingly, reprecipitation should be performed so that the size of a powder (particles) of the precipitated polymer is minimized to prevent impurities from being included in the polymer powder. However, regular solvents used in the production of polymers for lithography have high viscosities, whereby the resulting polymer solutions have high viscosities, and the polymer powder particles precipitated upon contact with a poor solvent have larger sizes. This impedes removal of impurities from the polymer powder.

If particles of the polymer precipitated upon contact with the poor solvent have larger sizes, the particles settle and deposit rapidly in the poor solvent to cause clogging of an extract port of the slurry. This remarkably occurs when a solvent having a low specific gravity, such as a hydrocarbon, is used as the poor solvent, or when the resulting polymer has a high specific gravity because of structurally containing a halogen atom and/or an aromatic substituent.

Proposals for improving the quality of such polymers are found typically in Patent Documents 1 and 2, but further improvements are demanded with further increasing fineness of pattering for the manufacture of semiconductor devices. As has been described, demands are made to provide a process for stably producing a polymer with less impurities according to an easy and convenient (simple) procedure.

Patent Document 1: Japanese Unexamined Patent Application Publication (JP-A) No. 2007-154061

Patent Document 2: Japanese Unexamined Patent Application Publication (JP-A) No. 2004-143281

### DISCLOSURE OF INVENTION

### Problems to be Solved by the Invention

The present invention has been made under these circumstances, and an object thereof is to provide a process for the production of copolymers adopted to lithography efficiently and with good reproducibility of quality, which copolymers are small in lot-to-lot variation, have stable quality, and are advantageously used in compositions for the formation of coated films used in fine patterning in the manufacture of semiconductor devices, such as a composition for the formation of a resist film, a composition for the formation of a bottom resist coat of a multilayer resist, and a composition for the formation of an anti-reflection coating.

### Means for Solving the Problems

After intensive investigations to achieve the object, the present inventors have found that a polymer, which contains less amounts of residual monomers, can be obtained by diluting a reaction solution obtained from polymerization and subjecting the diluted reaction solution to precipitation of the polymer from a poor solvent, in which the obtained polymer is useful typically as resist polymers, polymers for bottom resist coats of multilayer resists and polymers for anti-reflection coatings, and polymers for immersion topcoats (topcoats against immersion lithography). The present invention has been made based on these findings.

Specifically, the present invention provides, in an embodiment, a process for the production of a polymer. The process includes the steps of reacting or polymerizing a monomer or monomers in a solvent to give a polymer solution; and bringing the polymer solution into contact with a poor solvent to precipitate the polymer and to remove impurities therefrom, in which the polymer solution is combined with and diluted with a solvent before being brought into contact with the poor solvent to precipitate the polymer.

The solvent for use in the polymerization in the process may have a coefficient of viscosity at 20° C. of 1 mPa·s or more.

The solvent for use in the dilution in the process may have a coefficient of viscosity at 20° C. of less than 1 mPa·s.

The poor solvent for use in the precipitation in the process may contain a hydrocarbon compound.

### Advantages

The process for the production of a polymer according to the present invention can reduce the amounts of residual low-molecular-weight components, such as monomers used in polymerization, by performing a simple procedure after the polymerization. The reduction in amounts of residual low-molecular-weight components suppresses the occurrence of defects or contamination of an apparatus. Accordingly, the present invention can produce copolymers for lithography efficiently with good reproducibility of quality, which copolymers are small in lot-to-lot variations, have stable quality, and are advantageously used in compositions for the formation of coated films used in fine patterning in the manufacture of semiconductor devices, such as compositions for the formation of resist films, compositions for the formation of bottom resist coats of multilayer resists, and compositions for the formation of anti-reflection coatings.

### BEST MODES FOR CARRYING OUT THE INVENTION

As used herein, methacrylic compounds or moieties and acrylic compounds or moieties, such as methacrylic acid derivatives and acrylic acid derivatives, are also generically referred to typically as “(meth)acrylic” (acid derivative) or “(meth)acryloyl” (group).

Polymers produced according to the present invention are used typically for resists, for bottom resist coats of multilayer resists, for anti-reflection coatings, and for immersion topcoats.

### [As Resist Polymers]

The resist polymers can be adopted both to positive-working resist polymers and to negative-working resist polymers.

A copolymer, when used as a positive-working resist polymer, contains at least both a repeating unit having a group capable of becoming soluble in an alkali by the action of an acid and a repeating unit having a lactone skeleton as essential components, and may further contain one or more additional repeating units according to necessity. Specifically, the repeating unit having a group capable of becoming soluble in an alkali by the action of an acid may be a repeating unit having such a chemical structure that a nonpolar substituent is decomposed by the action of an acid to give a polar group soluble in an alkaline developer; the repeating unit having a lactone skeleton helps to impart adhesion with respect to a semiconductor substrate to the polymer; and the additional repeating units are added in order typically to control the solubility in a resist solvent or in an alkaline developer.

Exemplary monomers corresponding to the repeating unit (A) having a group capable of becoming soluble in an alkali by the action of an acid are represented by following Formulae (1a), (1b), (1c), and (1d). There can be stereoisomers respectively in the compounds represented by Formulae (1a), (1b), (1c), and (1d), and each of such stereoisomers can be used alone or in combination as a mixture.

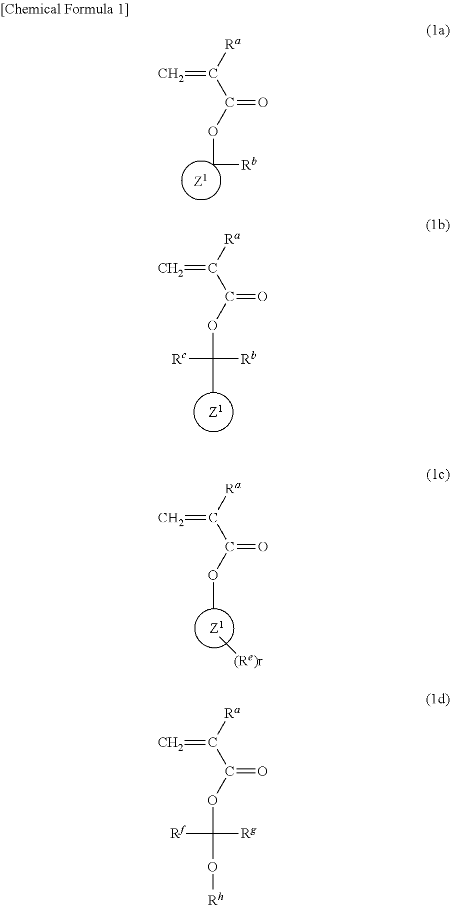

In Formulae (1a), (1b), (1c), and (1d), Ring Z¹ represents a substituted or unsubstituted alicyclic hydrocarbon group having 6 to 20 carbon atoms; R^{a} represents a hydrogen atom, a halogen atom, or an alkyl or haloalkyl group having 1 to 6 carbon atoms; R^{b}, R^{c}, and R^{d} are the same as or different from one another and each represent a substituted or unsubstituted alkyl group having 1 to 6 carbon atoms; R^{e}s are substituents bound to Ring Z¹, are the same as or different from each other, and each represent an oxo group, an alkyl group, a protected or unprotected hydroxyl group, a protected or unprotected hydroxyalkyl group, or a protected or unprotected carboxyl group, wherein at least one of rR^{e} represents a —COOR^{v} group, wherein R^{v} represents a substituted or unsubstituted tertiary hydrocarbon group, a tetrahydrofuranyl group, a tetrahydropyranyl group, or an oxepanyl group; “r” denotes an integer of 1 to 3; R^{f} and R^{g} are the same as or different from each other and each represent a hydrogen atom or a substituted or unsubstituted alkyl group having 1 to 6 carbon atoms; and R^{h} represents a hydrogen atom or an organic group, wherein at least two of R^{f}, R^{g}, and R^{h} may be bound to each other to form a ring with an adjacent atom or atoms.

In Formulae (1a), (1b), and (1c), the alicyclic hydrocarbon group having 6 to 20 carbon atoms as Ring Z¹ may be either a monocyclic ring or a polycyclic ring such as a fused ring or bridged ring. Representative exemplary alicyclic hydrocarbon rings include cyclohexane ring, cyclooctane ring, cyclodecane ring, adamantane ring, norbornane ring, norbornene ring, bornane ring, isobornane ring, perhydroindene ring, decahydronaphthalene ring, perhydrofluorene ring (tricyclo[7.4.0.0^{3,8}]tridecane ring), perhydroanthracene ring, tricyclo[5.2.1.0^{2,6}]decane ring, tricyclo[4.2.2.1^{2,5}]undecane ring, and tetracyclo[4.4.0.1^{2,5}. 1^{7,10}]dodecane ring. The alicyclic hydrocarbon rings may each have one or more substituents. Exemplary substituents include methyl group and other alkyl groups (of which alkyl groups having 1 to 4 carbon atoms are preferred); chlorine atom and other halogen atoms; protected or unprotected hydroxyl groups; oxo group; and protected or unprotected carboxyl groups. Ring Z¹ is preferably a polycyclic alicyclic hydrocarbon ring (bridged hydrocarbon ring) such as adamantane ring.

Exemplary halogen atoms as R^{a} include fluorine atom and chlorine atom. Exemplary alkyl groups having 1 to 6 carbon atoms as R^{a} include methyl, ethyl, propyl, isopropyl, butyl, pentyl, and hexyl groups. R^{a} is preferably hydrogen atom, fluorine atom, or an alkyl or fluoroalkyl group having 1 to 4 carbon atom.

As R^{b}, R^{c}, R^{d}, R^{f}, and R^{g} in Formulae (1a), (1b), and (1d), exemplary substituted or unsubstituted alkyl groups having 1 to 6 carbon atoms include linear or branched-chain alkyl groups having 1 to 6 carbon atoms, such as methyl, ethyl, propyl, isopropyl, butyl, isobutyl, s-butyl, t-butyl, and hexyl groups; and haloalkyl groups having 1 to 6 carbon atoms, such as trifluoromethyl group. As R^{e}s in Formula (1c), exemplary alkyl groups include linear or branched-chain alkyl groups having about 1 to 20 carbon atoms, such as methyl, ethyl, propyl, isopropyl, butyl, isobutyl, s-butyl, t-butyl, hexyl, octyl, decyl, and dodecyl groups. Exemplary protected or unprotected hydroxyl groups as R^{e}s include hydroxyl group; and substituted oxy groups including alkoxy groups having 1 to 4 carbon atoms, such as methoxy, ethoxy, and propoxy groups. Exemplary protected or unprotected hydroxyalkyl groups include groups composed of any of the protected or unprotected hydroxyl groups bound through an alkylene group having 1 to 6 carbon atoms. Exemplary protected or unprotected carboxyl groups include a —COOR^{w} group, in which R^{w} represents a hydrogen atom or an alkyl group. Examples of the alkyl group include linear or branched-chain alkyl groups having 1 to 6 carbon atoms, such as methyl, ethyl, propyl, isopropyl, butyl, isobutyl, s-butyl, t-butyl, and hexyl groups. Exemplary tertiary hydrocarbon groups as R^{v} in the —COOR^{v} group as R^{e} include t-butyl, t-amyl, 2-methyl-2-adamantyl, and (1-methyl-1-adamantyl)ethyl groups. Exemplary tetrahydrofuranyl groups include 2-tetrahydrofuranyl group; exemplary tetrahydropyranyl groups include 2-tetrahydropyranyl group; and exemplary oxepanyl groups include 2-oxepanyl group.

As R^{h}, exemplary organic groups include groups having a hydrocarbon group and/or a heterocyclic group. Examples of the hydrocarbon group include aliphatic hydrocarbon groups, alicyclic hydrocarbon groups, aromatic hydrocarbon groups, and groups containing two or more of these groups bound to each other. Exemplary aliphatic hydrocarbon groups include methyl, ethyl, propyl, isopropyl, butyl, isobutyl, s-butyl, t-butyl, hexyl, octyl, and other linear or branched-chain alkyl groups, of which alkyl groups having 1 to 8 carbon atoms are preferred; allyl group and other linear or branched-chain alkenyl groups, of which alkenyl groups having 2 to 8 carbon atoms are preferred; and propynyl group and other linear or branched-chain alkynyl groups, of which alkynyl groups having 2 to 8 carbon atoms are preferred. Exemplary alicyclic hydrocarbon groups include cyclopropyl, cyclopentyl, cyclohexyl, and other cycloalkyl groups, of which cycloalkyl groups having 3 to 8 members are preferred; cyclopentenyl, cyclohexenyl, and other cycloalkenyl groups, of which cycloalkenyl groups having 3 to 8 members are preferred); and adamantyl, norbornyl, and other bridged carbocyclic groups, of which bridged carbocyclic groups having 4 to 20 carbon atoms are preferred. Exemplary aromatic hydrocarbon groups include aromatic hydrocarbon groups having 6 to 14 carbon atoms, such as phenyl and naphthyl groups. Exemplary groups containing an aliphatic hydrocarbon group and an aromatic hydrocarbon group bound to each other include benzyl and 2-phenylethyl groups. These hydrocarbon groups may each have one or more substituents. Exemplary substituents herein include alkyl groups such as alkyl groups having 1 to 4 carbon atoms; haloalkyl groups such as haloalkyl groups having 1 to 4 carbon atoms; halogen atoms; protected or unprotected hydroxyl groups; protected or unprotected hydroxymethyl groups; protected or unprotected carboxyl groups; and oxo group. Protecting groups customarily used in organic syntheses can be used as protecting groups for these groups.

Examples of the heterocyclic group include heterocyclic groups each containing at least one heteroatom selected from the group consisting of oxygen atoms, sulfur atoms, and nitrogen atoms.

Preferred examples of the organic group include alkyl groups having 1 to 8 carbon atoms, and organic groups having a cyclic skeleton. Examples of the “ring” constituting the cyclic skeleton include monocyclic or polycyclic, nonaromatic or aromatic carbocyclic rings or heterocyclic rings. Among them, monocyclic or polycyclic nonaromatic carbocyclic rings and lactone rings are preferred. One or more nonaromatic carbocyclic rings may be fused to the lactone rings. Exemplary monocyclic nonaromatic carbocyclic rings include cycloalkane rings having about 3 to 15 members, such as cyclopentane ring and cyclohexane ring.

Exemplary polycyclic nonaromatic carbocyclic rings (bridged carbocyclic rings) include adamantane ring; rings each containing a norbornane ring or norbornene ring, such as norbornane ring, norbornene ring, bornane ring, isobornane ring, tricyclo[5.2.1.0^{2,6}]decane ring, and tetracyclo[4.4.0.1^{2,5}. 1^{7,10}]dodecane ring; rings corresponding to polycyclic aromatic fused rings, except for being hydrogenated, such as perhydroindene ring, decahydronaphthalene ring (perhydronaphthalene ring), perhydrofluorene ring (tricyclo[7.4.0.0^{3,8}]tridecane ring), and perhydroanthracene ring, of which fully hydrogenated rings are preferred; and bridged carbocyclic rings including bicyclic, tricyclic, or tetracyclic bridged carbocyclic rings such as tricyclo[4.2.2.1^{2,5}]undecane ring, of which bridged carbocyclic rings having about 6 to 20 carbon atoms are preferred. Examples of the lactone rings include γ-butyrolactone ring, 4-oxatricyclo[4.3.1.1^{3,8}]undecan-5-one ring, 4-oxatricyclo[4.2.1.0^{3,7}]nonan-5-one ring, and 4-oxatricyclo[5.2.1.0^{2,6}]decan-5-one ring.

The ring constituting the cyclic skeleton may have one or more substituents. Exemplary substituents include methyl group and other alkyl groups, of which alkyl groups having 1 to 4 carbon atoms are preferred; trifluoromethyl group and other haloalkyl groups, of which haloalkyl groups having 1 to 4 carbon atoms are preferred; chlorine atom, fluorine atom, and other halogen atoms; protected or unprotected hydroxyl groups; protected or unprotected hydroxyalkyl groups; protected or unprotected mercapto groups; protected or unprotected carboxyl groups; protected or unprotected amino groups; and protected or unprotected sulfonic groups. Protecting groups customarily used in organic syntheses can be used as protecting groups for these groups.

The ring constituting the cyclic skeleton may be bound to the oxygen atom (oxygen atom at the adjacent position to R^{h}) shown in Formula (1d) either directly or indirectly through a linkage group. Exemplary linkage groups include linear or branched-chain alkylene groups such as methylene, methylmethylene, dimethylmethylene, ethylene, propylene, and trimethylene groups; carbonyl group; oxygen atom (ether bond; —O—); oxycarbonyl group (ester bond; —COO—); aminocarbonyl group (amide bond; —CONH—); and groups containing two or more of these bound to each other.

At least two of R^{f}, R^{g}, and R^{h} may be bound to each other to form a ring with an adjacent atom or atoms. Examples of the ring include cycloalkane rings such as cyclopropane ring, cyclopentane ring, and cyclohexane ring; oxygen-containing rings such as tetrahydrofuran ring, tetrahydropyran ring, and oxepane ring; and bridged rings.

Representative examples of the compounds represented by Formula (1a) include, but are not limited to, 2-(meth)acryloyloxy-2-methyladamantane, 1-hydroxy-2-(meth)acryloyloxy-2-methyladamantane, 5-hydroxy-2-(meth)acryloyloxy-2-methyladamantane, and 2-(meth)acryloyloxy-2-ethyladamantane.

Representative examples of the compounds represented by Formula (1b) include, but are not limited to, 1-(1-(meth)acryloyloxy-1-methylethyl)adamantane, 1-hydroxy-3-(1-(meth)acryloyloxy-1-methylethyl)adamantane, 1-(1-ethyl-1-(meth)acryloyloxypropyl)adamantane, and 1-(1-(meth)acryloyloxy-1-methylpropyl)adamantane.

Representative examples of the compounds represented by Formula (1c) include, but are not limited to, 1-t-butoxycarbonyl-3-(meth)acryloyloxyadamantane and 1-(2-tetrahydropyranyloxycarbonyl)-3-(meth)acryloyloxyadamantane.

Representative examples of the compounds represented by Formula (1d) include, but are not limited to, 1-adamantyloxy-1-ethyl(meth)acrylate, 1-adamantylmethyloxy-1-ethyl(meth)acrylate, 2-(1-adamantylethyl)oxy-1-ethyl(meth)acrylate, 1-bornyloxy-1-ethyl(meth)acrylate, 2-norbornyloxy-1-ethyl(meth)acrylate, 2-tetrahydropyranyl(meth)acrylate, and 2-tetrahydrofuranyl(meth)acrylate.

Each of the compounds represented by Formula (1d) can be prepared, for example, by reacting a corresponding vinyl ether compound with (meth)acrylic acid in the presence of an acid catalyst according to customary processes. Typically, 1-adamantyloxy-1-ethyl(meth)acrylate can be prepared by reacting 1-adamantyl vinyl ether with (meth)acrylic acid in the presence of an acid catalyst.

Monomers corresponding to the repeating unit having a lactone skeleton, which repeating unit imparts adhesion with respect to the substrate to the resist resins (resist polymers), are represented by following Formulae (2a), (2b), (2c), (2d), and (2e).

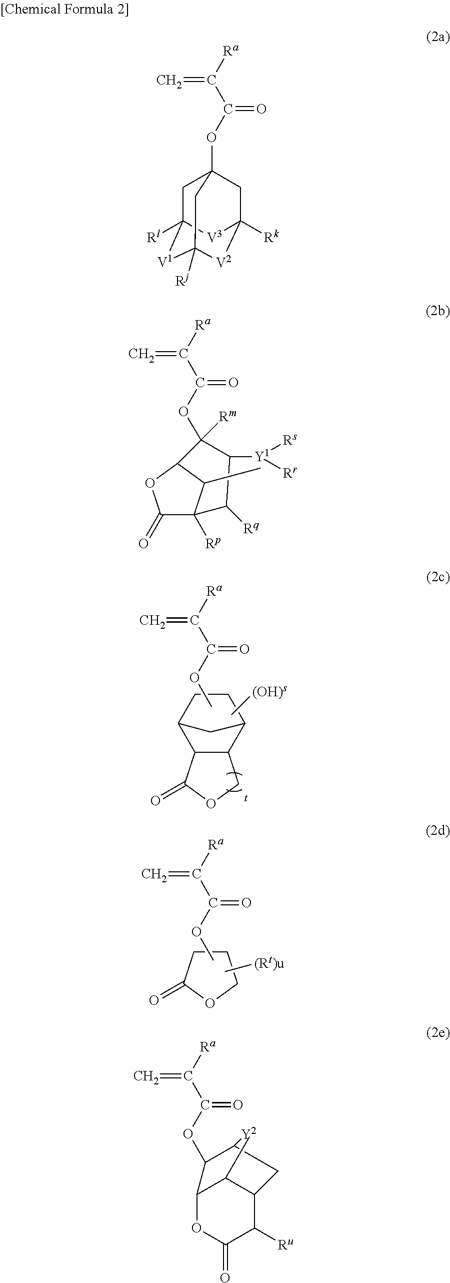

In Formulae (2a), (2b), (2c), (2d), and (2e), R^{a} is as defined above; Rⁱ, R^{j}, and R^{k} are the same as or different from one another and each represent a hydrogen atom, an alkyl group, a protected or unprotected hydroxyl group, a protected or unprotected hydroxyalkyl group, or a protected or unprotected carboxyl group; V¹, V², and V³ are the same as or different from one another and each represent —CH₂—, —CO—, or —COO—, wherein (i) at least one of V¹, V², and V³ is —CO— or —COO—, or (ii) at least one of Rⁱ, R^{j}, and R^{k} is a protected or unprotected hydroxyl group, a protected or unprotected hydroxyalkyl group, or a protected or unprotected carboxyl group; Y¹ represents a carbon atom, an oxygen atom, or a sulfur atom, and substituents R^{r} and R^{s} are present only when Y¹ is a carbon atom; R^{m}, Rⁿ, R^{o}, R^{p}, R^{q}, R^{r}, and R^{s} are the same as or different from one another and each represent a hydrogen atom, an alkyl group, a protected or unprotected hydroxyl group, a protected or unprotected hydroxyalkyl group, a protected or unprotected carboxyl group, cyano group, a halogen atom (e.g., fluorine atom or chlorine atom), or a fluorine-substituted alkyl group (fluoroalkyl group) having 1 to 6 carbon atoms; “t” denotes 1 or 2; “s” denotes an integer of 0 or 1; R^{t} represents a hydrogen atom, an alkyl group, a protected or unprotected hydroxyl group, a protected or unprotected hydroxyalkyl group, a protected or unprotected carboxyl group, a cyano group, a halogen atom (e.g., fluorine atom or chlorine atom), or a fluorine-substituted alkyl group (fluoroalkyl group) having 1 to 6 carbon atoms; “u” denotes an integer of 0 to 3; Y² represents a carbon atom, an oxygen atom, or a sulfur atom, and in the case of carbon atom, Y² is a methylene group; and R^{u} represents a hydrogen atom or an alkyl group having 1 to 6 carbon atoms.

As Rⁱ to R^{k}, R^{m} to R^{s}, and R^{t}, examples of the alkyl groups, protected or unprotected hydroxyl groups, protected or unprotected hydroxyalkyl groups, and protected or unprotected carboxyl groups are as with the above-exemplified alkyl groups and other corresponding groups as R^{e}.

Representative examples of compounds represented by Formula (2a) include, but are not limited to, 1-(meth)acryloyloxy-4-oxatricyclo[4.3.1.1]undecan-5-one, 1-(meth)acryloyloxy-4,7-dioxatricyclo[4.4.1.1^{3,9}]dodecane-5,8-dione, 1-(meth)acryloyloxy-4,8-dioxatricyclo[4.4.1.1^{3,9}]dodecane-5,7-dione, 1-(meth)acryloyloxy-5,7-dioxatricyclo[4.4.1.1^{3,9}]dodecane-4,8-dione, 1-(meth)acryloyloxy-3-hydroxyadamantane, 1-(meth)acryloyloxy-3,5-dihydroxyadamantane, 1-(meth)acryloyloxy-3,5,7-trihydroxyadamantane, 1-(meth)acryloyloxy-3-hydroxy-5,7-dimethyladamantane, and 1-(meth)acryloyloxy-3-carboxyadamantane.

Typically, representative examples of compounds represented by Formula (2b) in which Y¹ is a carbon atom include, but are not limited to, 5-(meth)acryloyloxy-3-oxatricyclo[4.2.1.0^{4,8}]nonan-2-one, 5-(meth)acryloyloxy-5-methyl-3-oxatricyclo[4.2.1.0^{4,8}]nonan-2-one, 5-(meth)acryloyloxy-1-methyl-3-oxatricyclo[4.2.1.0^{4,8}]nonan-2-one, 5-(meth)acryloyloxy-9-methyl-3-oxatricyclo[4.2.1.0^{4,8}]nonan-2-one, 5-(meth)acryloyloxy-9-carboxy-3-oxatricyclo[4.2.1.0^{4,8}]nonan-2-one, 5-(meth)acryloyloxy-9-methoxycarbonyl-3-oxatricyclo[4.2.1.0^{4,8}]nonan-2-one, 5-(meth)acryloyloxy-9-ethoxycarbonyl-3-oxatricyclo[4.2.1.0^{4,8}]nonan-2-one, and 5-(meth)acryloyloxy-9-t-butoxycarbonyl-3-oxatricyclo[4.2.1.0^{4,8}]nonan-2-one.

The representative examples further include 1-cyano-5-(meth)acryloyloxy-3-oxatricyclo[4.2.1.0^{4,8}]nonan-2-one, 1-fluoro-5-(meth)acryloyloxy-3-oxatricyclo[4.2.1.0^{4,8}]nonan-2-one, 1-chloro-5-(meth)acryloyloxy-3-oxatricyclo[4.2.1.0^{4,8}]nonan-2-one, 1-chloro-5-(meth)acryloyloxy-3-oxatricyclo[4.2.1.0^{4,8}]nonan-2-one, 1-trifluoromethyl-5-(meth)acryloyloxy-3-oxatricyclo[4.2.1.0^{4,8}]nonan-2-one, 9-cyano-5-(meth)acryloyloxy-3-oxatricyclo[4.2.1.0^{4,8}]nonan-2-one, 9-fluoro-5-(meth)acryloyloxy-3-oxatricyclo[4.2.1.0^{4,8}]nonan-2-one, 9-chloro-5-(meth)acryloyloxy-3-oxatricyclo[4.2.1.0^{4,8}]nonan-2-one, 9-chloro-5-(meth)acryloyloxy-3-oxatricyclo[4.2.1.0^{4,8}]nonan-2-one, and 9-trifluoromethyl-5-(meth)acryloyloxy-3-oxatricyclo[4.2.1.0^{4,8}]nonan-2-one.

Representative examples of compounds represented by Formula (2b) in which Y¹ is an oxygen atom include, but are not limited to, 1-cyano-5-(meth)acryloyloxy-3,7-dioxatricyclo[4.2.1.0^{4,8}]nonan-2-one, 1-fluoro-5-(meth)acryloyloxy-3,7-dioxatricyclo[4.2.1.0^{4,8}]nonan-2-one, 1-chloro-5-(meth)acryloyloxy-3,7-dioxatricyclo[4.2.1.0^{4,8}]nonan-2-one, 1-chloro-5-(meth)acryloyloxy-3,7-dioxatricyclo[4.2.1.0^{4,8}]nonan-2-one, 1-trifluoromethyl-5-(meth)acryloyloxy-3,7-dioxatricyclo[4.2.1.0^{4,8}]nonan-2-one, 9-cyano-5-(meth)acryloyloxy-3,7-dioxatricyclo[4.2.1.0^{4,8}]nonan-2-one, 9-fluoro-5-(meth)acryloyloxy-3,7-dioxatricyclo[4.2.1.0^{4,8}]nonan-2-one, 9-chloro-5-(meth)acryloyloxy-3,7-dioxatricyclo[4.2.1.0^{4,8}]nonan-2-one, 9-chloro-5-(meth)acryloyloxy-3,7-dioxatricyclo[4.2.1.0^{4,8}]nonan-2-one, and 9-trifluoromethyl-5-(meth)acryloyloxy-3,7-dioxatricyclo[4.2.1.0^{4,8}]nonan-2-one.

Representative examples of the compounds represented by Formula (2c) include, but are not limited to, 8-(meth)acryloyloxy-4-oxatricyclo[5.2.1.0^{2,6}]decan-5-one and 9-(meth)acryloyloxy-4-oxatricyclo[5.2.1.0^{2,6}]decan-5-one.

Representative examples of the compounds represented by Formula (2d) include, but are not limited to, α-(meth)acryloyloxy-γ-butyrolactones such as α-(meth)acryloyloxy-γ-butyrolactone, α-(meth)acryloyloxy-α-methyl-γ-butyrolactone, α-(meth)acryloyloxy-β,β-dimethyl-γ-butyrolactone, α-(meth)acryloyloxy-α,β,β-trimethyl-γ-butyrolactone, α-(meth)acryloyloxy-γ,γ-dimethyl-γ-butyrolactone, α-(meth)acryloyloxy-α,γ,γ-trimethyl-γ-butyrolactone, α-(meth)acryloyloxy-β,β,γ,γ-tetramethyl-γ-butyrolactone, α-(meth)acryloyloxy-α,β,β,γ,γ-pentamethyl-γ-butyrolactone, α-(meth)acryloyloxy-γ-butyrolactone, α-(meth)acryloyloxy-α-methyl-γ-butyrolactone, α-(meth)acryloyloxy-β,β-dimethyl-γ-butyrolactone, α-(meth)acryloyloxy-α,β,β-trimethyl-γ-butyrolactone, α-(meth)acryloyloxy-γ,γ-dimethyl-γ-butyrolactone, α-(meth)acryloyloxy-α,γ,γ-trimethyl-γ-butyrolactone, α-(meth)acryloyloxy-β,β,γ,γ-tetramethyl-γ-butyrolactone, and α-(meth)acryloyloxy-α,β,β,γ,γ-pentamethyl-γ-butyrolactone; and β-(meth)acryloyloxy-γ-butyrolactones such as β-(meth)acryloyloxy-γ-butyrolactone and β-(meth)acryloyloxy-γ-butyrolactone.

Representative examples of the compounds represented by Formula (2e) include, but are not limited to, for example, 5-(meth)acryloyloxy-4-oxatricyclo[5.2.1.0^{5,9}]decan-3-one, 2-methyl-5-(meth)acryloyloxy-4-oxatricyclo[5.2.1.0^{5,9}]decan-3-one, 2-ethyl-5-(meth)acryloyloxy-4-oxatricyclo[5.2.1.0^{5,9}]decan-3-one, 5-(meth)acryloyloxy-4,8-dioxatricyclo[5.2.1.0^{5,9}]decan-3-one, 2-methyl-5-(meth)acryloyloxy-4,8-dioxatricyclo[5.2.1.0^{5,9}]decan-3-one, and 2-ethyl-5-(meth)acryloyloxy-4,8-dioxatricyclo[5.2.1.0^{5,9}]decan-3-one.

Exemplary additional monomer components for use in copolymerization include acrylic ester compounds such as methyl acrylate, n-butyl acrylate, cyclohexyl acrylate, 2,2,2-trifluoroethyl acrylate, 2-methoxyethyl acrylate, methoxytriethylene glycol acrylate, tetrahydrofurfuryl acrylate, 3-methoxybutyl acrylate, and 3-acryloxypropyltrimethoxysilane; methacrylic ester compounds such as methyl methacrylate, isobutyl methacrylate, n-octyl methacrylate, 2,2,2-tribromoethyl methacrylate, 2-chloroethyl methacrylate, 2-ethoxyethyl methacrylate, methoxytriethylene glycol methacrylate, tetrahydrofurfuryl methacrylate, 2-(trimethylsiloxy)ethyl methacrylate, 3-methacryloxypropylmethyldimethoxysilane, and 3-methacryloxypropyltriethoxysilane; silane compounds such as vinyltrichlorosilane, vinyltrimethoxysilane, allyltrimethylsilane, allylaminotrimethylsilane, and allyldimethylpiperidinomethylsilane; acrylamide compounds such as N-methylacrylamide and N,N-diethylacrylamide; methacrylamide compounds such as N-propylmethacrylamide and N,N-dimethylacrylamide; vinyl compounds such as vinyl alcohol, methyl vinyl ether, 2-hydroxyethyl vinyl ether, 2-chloroethyl vinyl ether, and 2-methoxyethyl vinyl ether; maleimide compounds such as maleimide, N-methylmaleimide, and N-phenylmaleimide; maleic anhydride; acrylonitrile; and other monomers such as 1-(meth)acryloyloxy-3-[2-(trimethoxysilyl)ethyladamantane, 2-(trimethoxysilyl)ethyl(meth)acrylate, 3-(trimethoxysilyl)propyl(meth)acrylate, 2-(trimethylsilyloxy)ethyl(meth)acrylate, 3-(trimethylsilyloxy)propyl(meth)acrylate, ethyl 2-(trimethylsilylmethyl)acrylate, propyl 2-(trimethylsilylmethyl)acrylate, butyl 2-(trimethylsilylmethyl)acrylate, hexyl 2-(trimethylsilylmethyl) acrylate, cyclohexyl 2-(trimethylsilylmethyl)acrylate, adamantyl 2-(trimethylsilylmethyl)acrylate, 1-(1-(meth)acryloyloxy-1-methylethyl)adamantane, 1-hydroxy-3-(1-(meth)acryloyloxy-1-methylethyl)adamantane, 1-(1-ethyl-1-(meth) acryloyloxypropyl)adamantane, 1-hydroxy-3-(1-ethyl-1-(meth)acryloyloxypropyl)adamantane, 1-(1-(meth)acryloyloxy-1-methylpropyl)adamantane, 1-hydroxy-3-(1-(meth)acryloyloxy-1-methylpropyl)adamantane, 1-(1-(meth)acryloyloxy-1,2-dimethylpropyl)adamantane, 1-hydroxy-3-(1-(meth)acryloyloxy-1,2-dimethylpropyl)adamantane, 1,3-dihydroxy-5-(1-(meth)acryloyloxy-1-methylethyl)adamantane, 1-(1-ethyl-1-(meth)acryloyloxypropyl)-3,5-dihydroxyadamantane, 1,3-dihydroxy-5-(1-(meth)acryloyloxy-1-methylpropyl)adamantane, 1,3-dihydroxy-5-(1-(meth)acryloyloxy-1,2-dimethylpropyl)adamantane, 1-t-butoxycarbonyl-3-(meth)acryloyloxyadamantane, 1,3-bis(t-butoxycarbonyl)-5-(meth)acryloyloxyadamantane, 1-t-butoxycarbonyl-3-hydroxy-5-(meth)acryloyloxyadamantane, 1-(2-tetrahydropyranyloxycarbonyl)-3-(meth)acryloyloxyadamantane, 1,3-bis(2-tetrahydropyranyloxycarbonyl)-5-(meth)acryloyloxyadamantane, 1-hydroxy-3-(2-tetrahydropyranyloxycarbonyl)-5-(meth)acryloyloxyadamantane, 2-(meth)acryloyloxy-2-methyladamantane, 1-hydroxy-2-(meth)acryloyloxy-2-methyladamantane, 5-hydroxy-2-(meth)acryloyloxy-2-methyladamantane, 1,3-dihydroxy-2-(meth)acryloyloxy-2-methyladamantane, 1,5-dihydroxy-2-(meth)acryloyloxy-2-methyladamantane, 1,3-dihydroxy-6-(meth)acryloyloxy-6-methyladamantane, 2-(meth)acryloyloxy-2-ethyladamantane, 1-hydroxy-2-(meth)acryloyloxy-2-ethyladamantane, 5-hydroxy-2-(meth)acryloyloxy-2-ethyladamantane, 1,3-dihydroxy-2-(meth)acryloyloxy-2-ethyladamantane, 1,5-dihydroxy-2-(meth)acryloyloxy-2-ethyladamantane, 1,3-dihydroxy-6-(meth)acryloyloxy-6-ethyladamantane, 2-tetrahydropyranyl(meth)acrylate, 2-tetrahydrofuranyl(meth)acrylate, β-(meth)acryloyloxy-γ-butyrolactone, β-(meth)acryloyloxy-α,α-dimethyl-γ-butyrolactone, β-(meth)acryloyloxy-γ,γ-dimethyl-γ-butyrolactone, β-(meth)acryloyloxy-α,α,β-trimethyl-γ-butyrolactone, β-(meth)acryloyloxy-β,γ,γ-trimethyl-γ-butyrolactone, β-(meth)acryloyloxy-α,α,β,γ,γ-pentamethyl-γ-butyrolactone, 5-t-butoxycarbonylnorbornene, 9-t-butoxycarbonyltetracyclo[6.2.1.1^{3,6}.0^{2,7}]dodec-4-ene, 5-(2-tetrahydropyranyloxycarbonyl)norbornene, 9-(2-tetrahydropyranyloxycarbonyl)tetracyclo[6.2.1.1^{3,6}.0^{2,7}]dodec-4-ene, 1-(adamant-1-yloxy)ethyl(meth)acrylate, 1-(adamant-1-ylmethoxy)ethyl(meth)acrylate, 1-[2-(adamant-1-yl)ethoxy]ethyl(meth)acrylate, 1-(3-hydroxyadamant-1-yloxy)ethyl(meth)acrylate, 1-(norborn-2-yloxy)ethyl(meth)acrylate, 1-(norborn-2-ylmethoxy)ethyl(meth)acrylate, 1-(2-methylnorborn-2-yloxy)ethyl(meth)acrylate, 1-[1-(norborn-2-yl)-1-methylethoxy]ethyl(meth)acrylate, 1-(3-methylnorborn-2-ylmethoxy)ethyl(meth)acrylate, 1-(bornyloxy)ethyl(meth)acrylate, 1-(isobornyloxy)ethyl(meth)acrylate; and further other monomers such as 1-[1-(meth)acryloyloxyethoxy)-4-oxatricyclo[4.3.1.1^{3,8}]undecan-5-one, 2-[1-(meth)acryloyloxyethoxy]-4-oxatricyclo[4.2.1.0^{3,7}]nonan-5-one, 8-[1-(meth)acryloyloxyethoxy]-4-oxatricyclo[5.2.1.0^{2,6}]decan-5-one, 9-[1-(meth)acryloyloxyethoxy]-4-oxatricyclo[5.2.1.0^{2,6}]decan-5-one, α-[1-(meth)acryloyloxyethoxy]-γ,γ-dimethyl-γ-butyrolactone, 3-[1-(meth)acryloyloxyethoxy]-2-oxo-1-oxaspiro[4.5]decane, α-[1-(meth)acryloyloxyethoxy]-γ-butyrolactone, α-[1-(meth)acryloyloxyethoxy]-α,γ,γ-trimethyl-γ-butyrolactone, α-[1-(meth)acryloyloxyethoxy]-β,β-dimethyl-γ-butyrolactone, 1-hydroxy-3-(meth) acryloyloxyadamantane, 1,3-dihydroxy-5-(meth) acryloyloxyadamantane, 1-carboxy-3-(meth) acryloyloxyadamantane, 1,3-dicarboxy-5-(meth) acryloyloxyadamantane, 1-carboxy-3-hydroxy-5-(meth)acryloyloxyadamantane, 1-(meth)acryloyloxy-4-oxoadamantane, 3-hydroxy-1-(meth)acryloyloxy-4-oxoadamantane, 7-hydroxy-1-(meth)acryloyloxy-4-oxoadamantane, 1-(meth)acryloyloxy-4-oxatricyclo[4.3.1.1^{3,8}]undecan-5-one, 1-(meth)acryloyloxy-4,7-dioxatricyclo[4.4.1.1^{3,9}]dodecane-5,8-dione, 1-(meth)acryloyloxy-4,8-dioxatricyclo[4.4.1.1^{3,9}]dodecane-5,7-dione, 1-(meth)acryloyloxy-5,7-dioxatricyclo[4.4.1.1^{3,9}]decane-4,8-dine, 2-(meth)acryloyloxy-4-oxatricyclo[4.2.1.0^{3,7}]nonan-5-one, 2-(meth)acryloyloxy-2-methyl-4-oxatricyclo[4.2.1.0^{3,7}]nonan-5-one, α-(meth)acryloyloxy-γ-butyrolactone, α-(meth)acryloyloxy-α-methyl-γ-butyrolactone, α-(meth)acryloyloxy-β,β-dimethyl-γ-butyrolactone, α-(meth)acryloyloxy-α,β,β-trimethyl-γ-butyrolactone, α-(meth)acryloyloxy-γ,γ-dimethyl-γ-butyrolactone, α-(meth)acryloyloxy-α,γ,γ-trimethyl-γ-butyrolactone, α-(meth)acryloyloxy-β,β,γ,γ-tetramethyl-γ-butyrolactone, α-(meth)acryloyloxy-α,β,β,γ,γ-pentamethyl-γ-butyrolactone, (meth)acrylic acid, methyl(meth)acrylate, ethyl(meth)acrylate, isopropyl(meth)acrylate, n-butyl(meth)acrylate, cyclohexyl(meth)acrylate, decahydronaphthyl(meth)acrylate, norbornyl(meth)acrylate, isobornyl(meth)acrylate, adamantyl(meth)acrylate, dimethyladamantyl(meth)acrylate, tricyclo[5.2.1.0^{2,6}]decyl(meth)acrylate, tetracyclo[4.4.0.1^{2,5}.1^{7,10}]dodecyl(meth)acrylate, maleic anhydride, 4-oxatricyclo[5.2.1.0^{2,6}]dec-8-en-5-one, 3-oxatricyclo[5.2.1.0^{2,6}]dec-8-en-4-one, 5-oxatricyclo[6.2.1.0^{2,7}]undec-9-en-6-one, 4-oxatricyclo[6.2.1.0^{2,7}]undec-9-en-5-one, 4-oxapentacyclo[6.5.1.1^{9,12}.0^{2,6}.0^{8,13}]pentadec-10-en-5-one, 3-oxapentacyclo[6.5.1.1^{9,12}.0^{2,6}.0^{8,13}]pentadec-10-en-4-one, oxapentacyclo[6.6.1.1^{10,13}.0^{2,7}.0^{9,14}]hexadec-11-en-6-one, 4-oxapentacyclo[6.6.1.1^{10,13}.0^{2,7}.0^{9,14}]hexadec-11-en-5-one, norbornene, and 5-hydroxy-2-norbornene.

In addition to the above-mentioned monomers, one or more other monomers copolymerizable with these monomers can be used in copolymerization.

### [As Polymers for Bottom Resist Coats of Multilayer Resists and for Anti-Reflection Coatings]

Copolymers for use as polymers for bottom resist coats of multilayer resists and for anti-reflection coatings preferably contain, as a copolymerized component, one or more monomers having a structure capable of absorbing excimer laser beams such as KrF or ArF excimer laser beams. Examples of the monomers include vinyl compounds such as styrene, methylstyrenes, hydroxystyrenes, methoxystyrenes, cyanostyrenes, chlorostyrenes, bromostyrenes, acetylstyrenes, α-methylstyrene, α-chlorostyrene, vinylnaphthalene, and vinylanthracene; acrylic ester compounds such as phenyl acrylate, benzyl acrylate, naphthyl acrylate, anthryl acrylate, anthrylmethyl acrylate, 2-phenylethyl acrylate, hydroxyphenyl acrylate, and bromophenyl acrylate; and methacrylic ester compounds such as phenyl methacrylate, benzyl methacrylate, naphthyl methacrylate, anthryl methacrylate, anthrylmethyl methacrylate, 2-phenylethyl methacrylate, hydroxyphenyl methacrylate, and bromophenyl methacrylate.

The copolymers used for the formation of anti-reflection coatings should contain crosslinking points. Exemplary crosslinking points include reactive substituents capable of undergoing crosslinking typically through ester bond or urethane bond, such as hydroxyl group, amino group, carboxyl group, and epoxy group. Exemplary monomers appropriately usable herein and having such a reactive substituent acting as a crosslinking point include hydroxystyrenes such as p-hydroxystyrene and m-hydroxystyrene; as well as monomers corresponding to the above-exemplified polymerizable compounds, except for being substituted with one or more of the reactive substituents such as hydroxyl group, amino group, carboxyl group, and epoxy group.

The copolymers may further contain, in addition to the above monomer or monomers, one or more monomers copolymerizable with the monomers. Exemplary copolymerizable monomers include the monomers listed as the resist monomers.

### [As Polymers for Topcoats]

Examples of the topcoats (also referred to as “protective films”) include protective films for inhibiting the resist from having a “T-top” profile by the action of environmental amines; overcoat anti-reflection coatings; and protective films against immersion lithography (immersion topcoats). As the polymers, any materials will do, as long as having no interaction with the resist film and being capable of protecting the resist from external influence. Examples of such materials include water-soluble resins such as polyvinyl ether)s and polyvinylpyrrolidones; perfluoroalkyl compounds; fluorocarbon resins; and copolymers between a monomer having a fluorine-substituted functional group and a monomer having a functional group such as carboxyl group, sulfonyl group, or a repeating unit having an alcoholic hydroxyl group containing a fluoroalkyl group at least on the carbon atom at the alpha position.

When used as protective polymers against immersion lithography, especially preferred are copolymers containing both a fluorine-containing repeating unit imparting water repellency with respect to an immersion liquid; and a repeating unit having a functional group imparting solubility in an alkaline developer, such as carboxyl group or sulfonyl group. These copolymers show satisfactory resistance to the immersion liquid and can be easily treated after the exposure treatment.

Exemplary fluorine-containing repeating units include units represented by following Formulae (III) and Formula (IV):

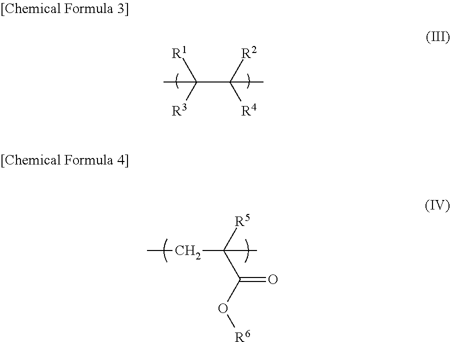

In Formulae (III) and (IV), R¹, R², R³, and R⁴ are the same as or different from one another and each represent a hydrogen atom, a fluorine atom, a hydroxyl-substituted or -unsubstituted alkyl group having 1 to 10 carbon atoms, a hydroxyl-substituted or -unsubstituted cycloalkyl group having 3 to 15 carbon atoms, a hydroxyl-substituted or -unsubstituted fluoroalkyl group having 1 to 10 carbon atoms, a hydroxyl-substituted or -unsubstituted fluorocycloalkyl group having 3 to 15 carbon atoms, a hydroxyl-substituted or -unsubstituted haloalkyloxy group having 1 to 10 carbon atoms, or a hydroxyl-substituted or -unsubstituted halocycloalkyloxy group having 3 to 10 carbon atoms, wherein R³ and R⁴ may be bound to each other to form a ring with the adjacent two carbon atoms, and wherein at least one of R¹, R², R³, and R⁴ is a fluorine-containing group; R⁵ represents a hydrogen atom, a fluorine atom, a methyl group, a trifluoromethyl group, or a carboxymethyl group; and R⁶ represents an aliphatic hydrocarbon group having 1 to 20 carbon atoms or alicyclic hydrocarbon group having 3 to 20 carbon atoms, which may be substituted and which may have an ester group, an ether group, a hydroxyl group, or an amide group, or represents a group containing two or more of these groups bound to each other.

As R¹, R², R³, and R⁴, exemplary alkyl groups having 1 to 10 carbon atoms include methyl, ethyl, propyl, isopropyl, butyl, isobutyl, s-butyl, t-butyl, pentyl, hexyl, octyl, and decyl groups. Exemplary cycloalkyl groups having 3 to 15 carbon atoms include cyclopentyl and cyclohexyl groups. Exemplary fluoroalkyl groups having 1 to 10 carbon atoms include trifluoromethyl group, trifluoroethyl group, and pentafluoroethyl group. Exemplary hydroxyl-substituted fluoroalkyl groups having 1 to 10 carbon atoms include —C(CF₃)₂—OH and —CH₂—C(CF₃)₂—OH. Exemplary fluorocycloalkyl groups having 3 to 15 carbon atoms include hexafluorocycloalkyl groups. Exemplary haloalkyloxy groups having 1 to 10 carbon atoms include —OCF₃, —OC₃F₇, —OC₄F₉, —OC₈F₁₇, —OCH₂CF₃, —OCH₂C₃F₇, and —OCH₂CF₂CF₂CF₂CF₂H. Examples of the ring formed by R³ and R⁴ with the adjacent two carbon atoms include cyclobutane ring which may have a fluorine atom or fluorine-containing group, cycloheptane ring which may have a fluorine atom or fluorine-containing group, cyclohexane ring which may have a fluorine atom or fluorine-containing group, and 1,3-dioxolane ring which may have a fluorine atom or fluorine-containing group.

As R⁶, exemplary aliphatic hydrocarbon groups having 1 to 20 carbon atoms include alkyl groups such as methyl, ethyl, propyl, isopropyl, butyl, s-butyl, t-butyl, pentyl, hexyl, octyl, and decyl groups; alkenyl groups such as allyl group; and alkynyl groups such as propynyl group. Exemplary alicyclic hydrocarbon groups having 3 to 20 carbon atoms, as R⁶, include cycloalkyl groups such as cyclopentyl and cyclohexyl groups; cycloalkenyl groups such as cyclopentenyl and cyclohexenyl groups; and bridged groups such as norbornyl and adamantyl groups. Though not limited, preferred examples of substituents which the aliphatic hydrocarbon groups and alicyclic hydrocarbon groups may have include fluorine atom and hydroxyl group.

Representative examples of the repeating units represented by Formula (III) include the following repeating units:

Repeating unit wherein R¹═H; R²═F; R³═H; and R⁴—H

Repeating unit wherein R¹═H; R²═F; R³═H; and R⁴═F

Repeating unit wherein R¹═H; R²═F; R³═F; and R⁴═F

Repeating unit wherein R¹═F; R²═F; R³═F; and R⁴═F

Repeating unit wherein R¹═H; R²═F; R³═H; and R⁴═CF₃

Repeating unit wherein R¹═F; R²═F; R³═H; and R⁴═CF₃

Repeating unit wherein R¹═F; R²═F; R³═F; and R⁴═CF₃

Repeating unit wherein R¹═H; R²═H; R³═H; and R⁴═OCF₃

Repeating unit wherein R¹═H; R²═H; R³═H; and R⁴═OC₃F₇

Repeating unit wherein R¹═H; R²═H; R³═H; and R⁴═OC₄F₉

Repeating unit wherein R¹═H; R²═H; R³═H; and R⁴═OC₈F₁₇

Repeating unit wherein R¹═H; R²═H; R³═H; and R⁴═OCH₂CF₃

Repeating unit wherein R¹═H; R²═H; R³═H; and R⁴═OCH₂C₃F₇

Repeating unit wherein R¹═F; R²═F; R³═F; and R⁴═OC₃F₇

Repeating unit wherein R¹═F; R²═F; and R³ and R⁴ are bound to each other to form, with the adjacent two carbon atoms, tetrafluorobutane ring

Repeating unit wherein R¹═F; R²═F; and R³ and R⁴ are bound to each other to form, with the adjacent two carbon atoms, hexafluoropentane ring

Repeating unit wherein R¹═F; R²═F; and R³ and R⁴ are bound to each other to form, with the adjacent two carbon atoms, 2,2-bis(trifluoromethyl)-1,3-dioxolane ring

Repeating unit wherein R¹═H; R²═H; and R³ and R⁴ are bound to each other to form, with the adjacent two carbon atoms, 2-(2,2,2-trifluoro-1-trifluoromethyl-1-hydroxyethyl)norbornane ring

Repeating unit wherein R¹═H; R²═H; and R³ and R⁴ are bound to each other to form, with the adjacent two carbon atoms, 2-(3,3,3-trifluoro-2-trifluoromethyl-1-hydroxypropyl)norbornane ring

Representative examples of the repeating units represented by Formula (1V) include the following repeating units:

Repeating units wherein R⁵═H, CH₃, F or CF₃; and R⁶═CH₂CF₃

Repeating units wherein R⁵═H, CH₃, F or CF₃; and R⁶═CH₂CF₂H

Repeating units wherein R⁵═H, CH₃, F or CF₃; and R⁶═CH₂CF₂CF₃

Repeating units wherein R⁵═H, CH₃, F or CF₃; and R⁶═CH₂CF₂CF₂H

Repeating units wherein R⁵═H, CH₃, F or CF₃; and R⁶═CH₂CF (CF₃)

Repeating units wherein R⁵═H, CH₃, F or CF₃; and R⁶═CH₂CF₂CFHCF₃

Repeating units wherein R⁵═H, CH₃, F or CF₃; and R⁶═CH₂CF₂CF₂CF₂CF₃

Repeating units wherein R⁵═H, CH₃, F or CF₃; and R⁶═CH₂CF₂CF₂CF₂CF₂H

Repeating units wherein R⁵═H, CH₃, F or CF₃; and R⁶═CH₂CH₂CF₂CF₂CF₂CF₃

Repeating units wherein R⁵═H, CH₃, F or CF₃; and R⁶═CH₂CF₂CF₂CF₂CF₂CF₂CF₂CF₂CF₃

Repeating units wherein R⁵═H, CH₃, F or CF₃; and R⁶═CH₂CH₂CF₂CF₂CF₂CF₂CF₂CF₂CF₃

Repeating units wherein R⁵═H, CH₃, F or CF₃; and R⁶=4-(2,2,2-trifluoro-1-trifluoromethyl-2-hydroxyethyl)cyclohexyl group

Repeating units wherein R⁵═H, CH₃, F or CF₃; and R⁶=2-(2,2,2-trifluoro-1-trifluoromethyl-2-hydroxyethyl)cyclohexyl group

Repeating units wherein R⁵═H, CH₃, F or CF₃; and R⁶=4-(1,1,3,3,3-pentafluoro-12-hydroxypropyl)cyclohexyl group

Repeating units wherein R⁵═H, CH₃, F or CF₃; and R⁶=4-(1,1,3,3,3-pentafluoro-12-hydroxypropyl)-4-hydroxycyclohexyl group

Repeating units wherein R⁵═H, CH₃, F or CF₃; and R⁶=4-(1,1,3,3,3-pentafluoro-12-hydroxypropyl)cyclohexyl-methyl group

Repeating units wherein R⁵═H, CH₃, F or CF₃; and R⁶=4-(1,1,3,3,3-pentafluoro-12-hydroxypropyl)-4-hydroxycyclohexyl-methyl group

Repeating units wherein R⁵═H, CH₃, F or CF₃; and R⁶=4-(1,1,2,2,3,3,4,4-octafluorobutyl)cyclohexyl group

Repeating units wherein R⁵═H, CH₃, F or CF₃; and R⁶=5-(2,2,2-trifluoro-1-trifluoromethyl-1-hydroxyethyl)norborn-2-yl group

Repeating units wherein R⁵═H, CH₃, F or CF₃; and R⁶=5-(3,3,3-trifluoro-2-trifluoromethyl-1-hydroxypropyl)norborn-2-yl group

Repeating units wherein R⁵═H, CH₃, F or CF₃; and R⁶=5-trifluoromethyl-5-hydroxynorborn-2-yl group

Repeating units wherein R⁵═H, CH₃, F or CF₃; and R⁶=6,6-difluoro-5-trifluoromethyl-5-hydroxynorborn-2-yl group

Repeating units wherein R⁵═H, CH₃, F or CF₃; and R⁶=6-(2,2,3,3,4,4,5,5-octafluoropentyloxycarbonyl)norborn-2-yl group

Repeating units wherein R⁵═H, CH₃, F or CF₃; and R⁶=6-(2,2,3,3,4,4,5,5,5-nonafluoropentyloxycarbonyl)norborn-2-yl group

The repeating unit having a sulfo group, a carboxyl group, or an alcoholic hydroxyl group containing a fluoroalkyl group at least on the carbon atom at the alpha position is not especially limited, as long as having a sulfo group, a carboxyl group, or an alcoholic hydroxyl group containing a fluoroalkyl group at least on the carbon atom at the alpha position.

Representative examples of unsaturated compounds (polymerizable monomers) corresponding to repeating units having a sulfo group include, but are not limited to, vinylsulfonic acid (ethylenesulfonic acid), 2-propenesulfonic acid, 3-butenesulfonic acid, 4-pentenesulfonic acid, sulfomethyl(meth)acrylate, 2-sulfoethyl(meth)acrylate, 3-sulfopropyl(meth)acrylate, 2-methyl-3-sulfopropyl(meth)acrylate, 4-sulfobutyl(meth)acrylate, 4-sulfobutyl N-(2-sulfoethyl)(meth)acrylate, N-(2-sulfoethyl)(meth)acrylamide, N-(1-methyl-2-sulfoethyl)(meth)acrylamide, N-(2-methyl-3-sulfopropyl)(meth)acrylamide, and N-(4-sulfobutyl)(meth)acrylamide.

Representative examples of unsaturated compounds (polymerizable monomers) corresponding to repeating units having a carboxyl group include (meth)acrylic acid, 3-butenoic acid, 4-pentenoic acid, 2-fluoroacrylic acid, 2-trifluoromethylacrylic acid, 3-vinyloxypropionic acid, 4-vinyloxybutyric acid, 3-carboxy-3-butenoic acid, carboxycyclohexyl(meth)acrylate, carboxynorbornyl(meth)acrylate, carboxyadamantyl(meth)acrylate, carboxymethyl(meth)acrylate, 2-carboxyethyl(meth)acrylate, and 3-carboxypropyl(meth)acrylate.

Representative examples of repeating units having an alcoholic hydroxyl group containing a fluoroalkyl group at least on the carbon atom at the alpha position include repeating units represented by following Formula (V):

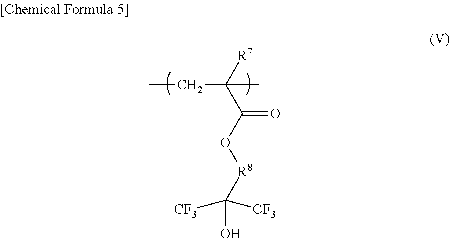

In Formula (V), R⁷ represents a hydrogen atom or an alkyl group having 1 to 4 carbon atom; and R⁸ represents a bivalent organic group.

As R⁷, exemplary alkyl groups having 1 to 4 carbon atoms include methyl group, ethyl group, n-propyl group, i-propyl group, n-butyl group, 2-methylpropyl group, 1-methylpropyl group, t-butyl group, and other alkyl groups.

As R⁸, preferred as bivalent organic groups are bivalent hydrocarbon groups, of which chain or cyclic hydrocarbon groups are more preferred.

Preferred examples as R⁸ include saturated chain hydrocarbon groups such as methylene group, ethylene group, propylene groups (e.g., 1,3-propylene group and 1,2-propylene group), tetramethylene group, pentamethylene group, hexamethylene group, heptamethylene group, octamethylene group, nonamethylene group, decamethylene group, undecamethylene group, dodecamethylene group, tridecamethylene group, tetradecamethylene group, pentadecamethylene group, hexadecamethylene group, heptadecamethylene group, octadecamethylene group, nonadecamethylene group, insalene group, 1-methyl-1,3-propylene group, 2-methyl-1,3-propylene group, 2-methyl-1,2-propylene group, 1-methyl-1,4-butylene group, 2-methyl-1,4-butylene group, methylidene group, ethylidene group, propylidene group, and 2-propylidene group; monocyclic hydrocarbon groups including cycloalkylene groups having 3 to 10 carbon atoms, such as cyclobutylene groups (e.g., 1,3-cyclobutylene group), cyclopentylene groups (e.g., 1,3-cyclopentylene group), cyclohexylene groups (e.g., 1,4-cyclohexylene group), and cyclooctylene groups (e.g., 1,5-cyclooctylene group); and bridged hydrocarbon groups including bicyclic, tricyclic, or tetracyclic bridged hydrocarbon groups having 4 to 30 carbon atoms, such as norbornylene groups (e.g., 1,4-norbornylene group and 2,5-norbornylene group) and adamantylene groups (e.g., 1,5-adamantylene group and 2,6-adamantylene group).

When the repeating units contain a bivalent aliphatic cyclic hydrocarbon group as R⁸, they preferably contain, as a spacer, an alkylene group having 1 to 4 carbon atoms between the bistrifluoromethyl-hydroxy-methyl group and the aliphatic cyclic hydrocarbon group. R⁸ is preferably a hydrocarbon group containing a 2,5-norbornylene group; ethylene group; or 1,2-propylene group.

In the polymer constituting a resin composition for the formation of resist-protective films, relating to the present invention, the content of repeating units corresponding to monomers for imparting polarity is typically about 1 to 99 percent by mole, preferably about 10 to 80 percent by mole, and more preferably about 15 to 70 percent by mole, based on the total amount of repeating units (total monomeric units). If the content of the repeating units is excessively small, the polymer may show insufficient solubility in an alkali, and this may often cause defects such as scum during development with an alkali developer. In contrast, if the content of the repeating units is excessively large, the polymer may show insufficient water repellency.

The content of fluorine-containing repeating units, when contained in the polymer, is typically about 1 to 99 percent by mole, preferably about 5 to 95 percent by mole, and more preferably about 10 to 90 percent by mole, based on the total amount of repeating units (total monomeric units). If the content of the fluorine-containing repeating units is excessively small, the polymer may show insufficient water repellency to often cause defects such as water marks. In contrast, if the content of the fluorine-containing repeating unit is excessively large, the polymer may often show insufficient alkali solubility.

The polymers for lithography, according to the present invention, have weight-average molecular weights (Mw; in terms of polystyrene as determined through gel permeation chromatography (GPC)) of typically about 1000 to 500000. Specifically, when the polymers are copolymers for protective films or for resists, they have weight-average molecular weights (Mw) of preferably about 2000 to 30000, and more preferably about 2000 to 15000. When the polymers are polymers for undercoat films, they have weight-average molecular weights (Mw) of preferably about 2000 to 300000, and more preferably about 3000 to 100000.

If the polymers have excessively small weight-average molecular weights, the resulting films may show insufficient strengths or may show insufficient performance as coatings. In contrast, if the polymers have excessively large weight-average molecular weights, they show inferior film formability during spin coating, and/or the resulting films may show insufficient solubility in a solvent.

To produce polymers for lithography according to the present invention, the polymerization of a mixture of monomers can be performed according to customary processes used in the production typically of acrylic polymers, such as solution polymerization, bulk polymerization, suspension polymerization, or emulsion polymerization, of which solution polymerization is preferred. Of such solution polymerization processes, dropping polymerization is preferred. Specifically, the drop polymerization can be performed, for example, by any of the following processes (i), (ii), (iii), and (iv). In the process (i), a solution of monomers in an organic solvent, and a solution of a polymerization initiator in the organic solvent are previously prepared respectively, and these solutions are respectively added dropwise to the organic solvent held to a constant temperature. In the process (ii), a mixed solution containing monomers and a polymerization initiator in an organic solvent is prepared and added dropwise to the organic solvent held to a constant temperature. In the process (iii), a solution of monomers in an organic solvent, and a solution of a polymerization initiator in the organic solvent are prepared respectively, and the solution of polymerization initiator is added dropwise to the solution of monomers held to a constant temperature. In the process (iv), a solution of monomers in an organic solvent, and a solution of a polymerization initiator in another organic solvent are previously prepared respectively, and the solution of monomers and the solution of polymerization initiator are respectively added to an organic solvent held to a constant temperature.

Though not critical, the monomer concentration in the polymerization reaction is preferably 10 percent by weight or more, based on the total weight of the reaction system. An excessively low monomer concentration is undesirable, because this requires a larger amount of the solvent to be used and a larger capacity of the reactor. The monomer concentration is more preferably 15 percent by weight or more, and still more preferably 20 percent by weight or more. Increase in monomer concentration in the reaction system effectively reduces the amount of raw materials to be used, effectively improves volumetric efficiency, and, in addition, effectively reduces the amounts of residual monomers. This is because as follows. The increase in monomer concentration reduces the ratio (occurrence) of chain transfer by the action of the solvent. Accordingly, to produce a polymer having the same molecular weight at an increased monomer concentration, reaction conditions may be controlled by 1) elevating the polymerization temperature, 2) increasing the (polymerization) initiator concentration, and/or 3) adding a chain-transfer agent. When the procedures 1) and 2) are adopted to the production of a polymer having the same molecular weight at an increased monomer concentration, monomers are consumed at a higher rate, and the content of monomers present in the system at the time when the reaction is completed decreases. This results in less amounts of monomers to be removed in the subsequent purification step and in less amounts of residual monomers in end products.

Any of known solvents can be used as the polymerization solvent, and examples thereof include ethers including chain ethers (e.g., diethyl ether, and glycol ethers such as propylene glycol monomethyl ether) and cyclic ethers (e.g., tetrahydrofuran and dioxane); esters such as methyl acetate, ethyl acetate, butyl acetate, ethyl lactate, and glycol ether esters (e.g., propylene glycol monomethyl ether acetate); ketones such as acetone, methyl ethyl ketone, methyl isobutyl ketone, and cyclohexanone; amides such as N,N-dimethylacetamide and N,N-dimethylformamide; sulfoxides such as dimethyl sulfoxide; alcohols such as methanol, ethanol, and propanol; hydrocarbon including aromatic hydrocarbons (e.g., benzene, toluene, and xylenes), aliphatic hydrocarbons (e.g., hexane), and alicyclic hydrocarbons (e.g., cyclohexane); and mixtures of these solvents. The polymerization solvent is preferably any of ether-, ester-, and ketone-based solvents, from the viewpoint of solubility of material monomers and of the polymer formed through polymerization. The solvent used herein preferably has a boiling point of preferably 80° C. or above, more preferably 100° C. or above, and still more preferably 120° C. or above, for ensuring safety in the polymerization reaction.

Though not critical, the polymerization solvent to be used has a viscosity in terms of viscosity number (coefficient of viscosity) at 20° C. of preferably 1 mPa·s or more, and more preferably 1.2 mPa·s or more. The polymerization solvent preferably has a kinematic viscosity at 20° C. of 1 mm²/s or more, and more preferably 1.2 mm²/s or more. The “kinematic viscosity” herein is determined by dividing the viscosity number (coefficient of viscosity) by the density. If a polymerization solvent having a viscosity number at 20° C. of less than 1 mPa·s is used, the monomers and polymer may not be sufficiently dissolved in the polymerization reaction solvent. Preferred examples of solvents having a viscosity number at 20° C. of 1 mPa·s or more include allyl alcohol, isobutyl alcohol, isopentyl alcohol, isobutyric acid, N-ethylaniline, ethylene glycol, ethoxytoluene, formic acid, valeric acid, cresol, N,N-diethylaniline, 1,4-dioxane, cyclohexanone, 1,2-dibromopropane, N,N-dimethylaniline, decahydronaphthalene, tetrahydronaphthalene, dodecane, toluidine, nitrotoluene, nitrobenzene, butanol, butyrophenone, 1-propanol, 2-propanol, propionic acid, propionic anhydride, propylene glycol monomethyl ether, propylene glycol monomethyl ether acetate, acetic acid, and pentyl acetate. Among them, preferred examples include cyclohexanone, 1-propanol, 2-propanol, propylene glycol monomethyl ether, propylene glycol monomethyl ether acetate, and mixtures of these solvents.

Each of these solvents can be used alone or in combination. The polymerization solvent may be composed of one or more solvents having a viscosity number at 20° C. of 1 mPa·s or more alone, but may be composed of one or more solvents having a viscosity number at 20° C. of 1 mPa·s or more in combination with one or more solvents having a viscosity number at 20° C. of less than 1 mPa·s. The polymerization solvent for use herein desirably contains at least one solvent having a viscosity number at 20° C. of 1 mPa·s or more in an amount of preferably 50 percent by weight or more, and especially preferably 70 percent by weight or more, based on the total weight of the polymerization solvent(s).

When free-radical polymerization is adopted, exemplary free-radical polymerization initiators include, but are not limited to, azo compounds, peroxide compounds, and redox compounds; of which preferred examples include dimethyl 2,2′-azobisisobutyrate, azobisisobutyronitrile, 2,2′-azobis(2-methylbutyronitrile), t-butyl peroxypivalate, di-t-butyl peroxide, iso-butyryl peroxide, lauroyl peroxide, succinyl peroxide, dicinnamyl peroxide, di-n-propyl peroxydicarbonate, t-butyl peroxyallyl monocarbonate, benzoyl peroxide, hydrogen peroxide, and ammonium persulfate.

The polymerization temperature can be appropriately chosen within ranges of typically about 30° C. to 150° C., preferably about 50° C. to 120° C., and more preferably about 55° C. to 110° C.

The resulting polymer may be subjected to a subsequent purification step without any treatment, but it may undergo formation of a crosslinked structure with a multifunctional crosslinking agent which is reactive typically with hydroxyl group and/or carboxyl group present in side chains of the polymer. Exemplary multifunctional crosslinking agents include compounds having two or more groups selected from vinyl ether groups, epoxy groups, and amino groups per one molecule. Among them, preferred are compounds having two or more vinyl ether groups or two or more epoxy groups per one molecule, because these compounds are easy to react.

Exemplary compounds each having two or more vinyl ether groups are as follows:

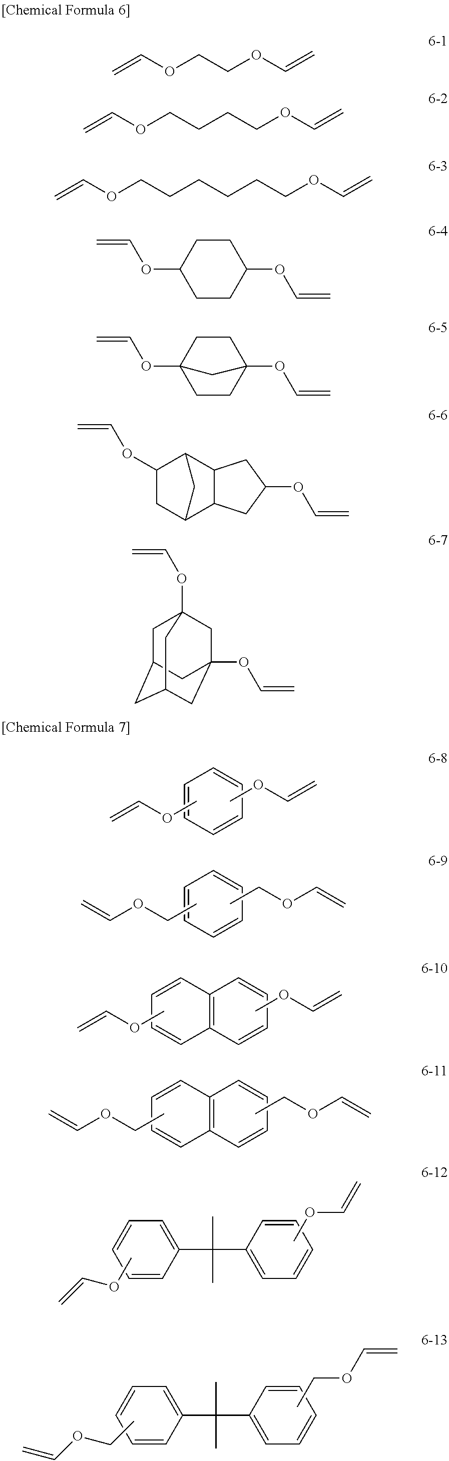

Exemplary compounds each having two or more epoxy groups are as follows:

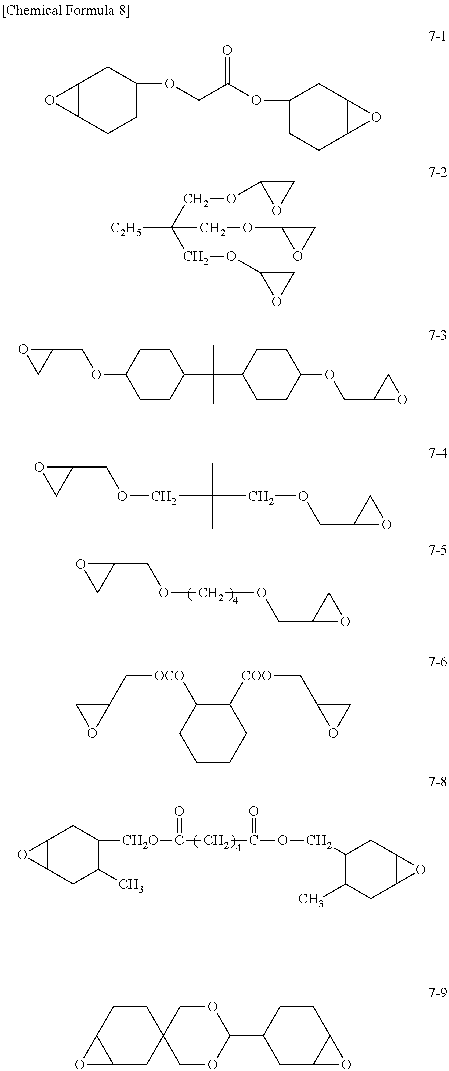

The produced polymer can be purified by diluting the polymer solution (solution containing the polymer) and carrying out precipitation or reprecipitation in which the diluted polymer solution is brought into contact with a poor solvent with respect to the polymer.

The polymer solution to be purified should be diluted with a solvent before being brought into contact with the poor solvent. Though not critical, the dilution ratio with the solvent is such that the diluted polymer solution has a polymer concentration (by weight) of preferably from 1 to 25 percent by weight (e.g., from 1 to 20 percent by weight), more preferably from 2 to 15 percent by weight, and still more preferably from 5 to 13 percent by weight. The diluted polymer solution, if having an excessively high polymer concentration, may give large polymer particles upon precipitation by the contact with a poor solvent, and such large polymer particles include larger amounts of impurities therein. In addition, such large polymer particles may rapidly settle and deposit, and, at worst, they may form aggregates, from which the polymer is difficult to be recovered. In contrast, the polymer solution, if having an excessively low polymer concentration, requires larger amounts of not only the solvent for use in the dilution but also the poor solvent. This may also increase the material cost and increase the size of an apparatus to be used.

The solvent for use in the dilution (dilution solvent) is not limited, as long as not causing the polymer to precipitate when the dilution solvent is added to the polymer solution, but the dilution solvent is preferably the same solvent as the polymerization solvent or a solvent having a boiling point lower than that of the polymerization solvent. A solvent having a boiling point higher than that of the polymerization solvent, if used, may not be sufficiently removed in the purification step and may remain in the polymer.

Though not critical, the dilution solvent has a viscosity in terms of a viscosity number at 20° C. (coefficient of viscosity) of preferably less than 1 mPa·s, and more preferably less than 0.8 mPa·s. The dilution solvent has a kinematic viscosity at 20° C. of preferably less than 1 mm²/s, and more preferably less than 0.8 mm²/s. The diluted polymer solution, if having been diluted with a solvent having a high viscosity, may have an insufficiently reduced viscosity upon contact with the poor solvent, and this may cause larger polymer particles, from which impurities may not effectively removed.

Preferred examples of the dilution solvent include acetaldehyde, acetone, ethylbenzene, methyl ethyl ketone, methyl isobutyl ketone, xylenes, isopropyl acetate, ethyl acetate, butyl acetate, propyl acetate, pentyl acetate, methyl acetate, diethyl ether, carbon tetrachloride, cyclohexane, tetrahydrofuran, toluene, nitromethane, carbon disulfide, nonane, pyridine, ethyl propionate, methyl propionate, 1,5-hexadiene, 2-hexanone, hexane, 4-heptanone, heptane, benzene, 2-pentanol, 3-pentanol, pentane, and acetic anhydride. Among them, preferred examples include ketones such as acetone, methyl ethyl ketone, and methyl isobutyl ketone; esters such as ethyl acetate; ethers such as tetrahydrofuran; and aliphatic hydrocarbons such as hexane and heptane, because the polymer is satisfactorily soluble in these solvents, and these solvents can be easily removed in the purification step.

Each of different dilution solvents can be used alone or in combination. The dilution solvent may be composed of one or more solvents having a viscosity number at 20° C. of less than 1 mPa·s alone but may be composed of one or more solvents having a viscosity number at 20° C. of less than 1 mPa·s in combination with one or more solvents having a viscosity number at 20° C. of 1 mPa·s or more. The dilution solvent is preferably composed of at least one solvent having a viscosity number at 20° C. of less than 1 mPa·s in an amount of preferably 50 percent by weight or more, and more preferably 70 percent by weight or more, based on the total weight of the dilution solvent.

The amount of the dilution solvent is typically about 10 to 300 parts by weight, preferably about 15 to 200 parts by weight, and more preferably about 20 to 150 parts by weight, per 100 parts by weight of the polymerization solvent contained in the polymer solution to be diluted.

The precipitation or reprecipitation solvent (poor solvent) may be either an organic solvent or water and may also be a solvent mixture. Exemplary organic solvents for use as the precipitation or reprecipitation solvent include hydrocarbons including aliphatic hydrocarbons (e.g., pentane, hexane, heptane, and octane), alicyclic hydrocarbons (e.g., cyclohexane and methylcyclohexane) and aromatic hydrocarbons (e.g., benzene, toluene, and xylenes); halogenated hydrocarbons including halogenated aliphatic hydrocarbons (e.g., methylene chloride, chloroform, and carbon tetrachloride) and halogenated aromatic hydrocarbons (e.g., chlorobenzene and dichlorobenzene); nitro compounds such as nitromethane and nitroethane; nitriles such as acetonitrile and benzonitrile; ethers including chain ethers (e.g., diethyl ether, diisopropyl ether, and dimethoxyethane) and cyclic ethers (e.g., tetrahydrofuran and dioxane); ketones such as acetone, methyl ethyl ketone, diisobutyl ketone; esters such as ethyl acetate and butyl acetate; carbonates such as dimethyl carbonate, diethyl carbonate, ethylene carbonate, and propylene carbonate; alcohols such as methanol, ethanol, propanol, isopropyl alcohol, and butanol; carboxylic acids such as acetic acid; and solvent mixtures containing these solvents.

Among them, a solvent containing at least a hydrocarbon (of which an aliphatic hydrocarbon such as hexane is preferred) is preferred as the organic solvent for use as the precipitation or reprecipitation solvent (poor solvent).

In the solvent containing at least a hydrocarbon, the ratio (by weight) of the hydrocarbon (for example, aliphatic hydrocarbon such as hexane) to another solvent or solvents is typically about 10/90 to 100/0, preferably about 30/70 to 100/0, and more preferably about 50/50 to 100/0.

The amount of the poor solvent for use in the precipitation is typically about 200 to 1500 parts by weight, preferably about 300 to 1200 parts by weight, and more preferably about 400 to 1000 parts by weight, per 100 parts by weight of the total weight of the polymerization solvent and the dilution solvent.

The polymer precipitated through precipitation or reprecipitation is collected or separated by filtration. Exemplary filtration procedures include natural filtration, filtration under pressure, filtration under reduced pressure, and centrifugal filtration. Of these procedures, centrifugal filtration is preferably chosen, because centrifugal separation shows high separation efficiency and gives a wet polymer containing the solvents uniformly in a small amount.

Though not critical, the amount of solvents contained in the wet polymer after separation is preferably 5 times by weight or less, more preferably 3 times by weight or less, and still more preferably 2 times by weight or less the weight of the polymer to be recovered, in consideration of the amounts of monomers, initiators, polymerization solvents, and formed impurities remaining in the product.

The wet polymer collected by filtration may be immediately recovered or may be subjected to a subsequent rinsing step without any further treatment.

Though not especially limited, a solvent for use in the rinsing step (rinsing solvent) preferably has a boiling point lower than that of a product solvent, because of easy removal through a concentration step. Though not critical, the rinsing solvent has a boiling point lower than that of the product solvent by preferably 5° C. or more, more preferably 10° C. or more, and still more preferably 20° C. or more. A rinsing solvent having a boiling point equal to or higher than the boiling point of the product solvent may be difficult to be removed in the subsequent concentration step, can thereby put a larger load on the concentration step, can remain as impurities in the product, or can cause other problems.

The rinsing solvent should be a poor solvent having low affinity for the polymer. A solvent having high affinity for the polymer, if used as the rinsing solvent, may cause the polymer, which has been dispersed as a powder, to be partially dissolved in the rinsing solvent to form a sticky block, from which impurities may not be removed sufficiently. In addition, such sticky block of the polymer may become resistant to dissolution in a subsequent step of dissolving the polymer in the product solvent, and this may prolong the dissolution time. If a solvent having further high affinity for the polymer is used, the polymer may be dissolved in a larger amount in the solvent, and this may lower the yield of the product polymer.

Whether a rinsing solvent is a poor solvent with respect to the polymer can be easily determined by mixing the powdery wet polymer with the rinsing solvent, leaving the mixture left stand for about one hour, and observing whether the wet polymer remains powdery.

Though not critical, the temperature during rinsing is preferably set high so that residual monomers, remaining in addition to the solvents, are more easily removed. The temperature of the rinsing solvent is preferably room temperature or higher. When the rinsing temperature is changed, whether the wet polymer is stably dispersed in the actual temperature (temperature after change) should be verified, because the rinsing solvent may change in affinity for the polymer at an elevated temperature.

The rinsing solvent can be either an organic solvent or water and can also be a solvent mixture. From the viewpoint of not increasing types of impurities, the rinsing solvent is preferably the solvent used in precipitation or reprecipitation.

Exemplary organic solvents for use as the rinsing solvent include hydrocarbons including aliphatic hydrocarbons (e.g., pentane, hexane, heptane, and octane), alicyclic hydrocarbons (e.g., cyclohexane and methylcyclohexane), and aromatic hydrocarbons (e.g., benzene, toluene, and xylenes); halogenated hydrocarbons including halogenated aliphatic hydrocarbons (e.g., methylene chloride, chloroform, and carbon tetrachloride) and halogenated aromatic hydrocarbons (e.g., chlorobenzene and dichlorobenzene; nitro compounds such as nitromethane and nitroethane; nitriles such as acetonitrile and benzonitrile; ethers including chain ethers (e.g., diethyl ether, diisopropyl ether, and dimethoxyethane) and cyclic ethers (e.g., tetrahydrofuran and dioxane); ketones such as acetone, methyl ethyl ketone, and diisobutyl ketone; esters such as ethyl acetate and butyl acetate; carbonates such as dimethyl carbonate, diethyl carbonate, ethylene carbonate, and propylene carbonate; alcohols such as methanol, ethanol, propanol, isopropyl alcohol, and butanol; carboxylic acids such as acetic acid; and solvent mixtures containing these solvents.

Among them, a solvent containing at least a hydrocarbon (of which an aliphatic hydrocarbon such as hexane is preferred) is preferred as the organic solvent for use as the rinsing solvent. In the solvent containing at least a hydrocarbon, the ratio (by weight) of the hydrocarbon (e.g., an aliphatic hydrocarbon such as hexane) to another solvent is typically about 10/90 to 100/0, preferably about 30/70 to 100/0, and more preferably about 50/50 to 100/0.

The rinsing solvent can be used in an amount within the range of 1 to 100 times, preferably 2 to 50 times, and more preferably 5 to 20 times the weight of the polymer. The rinsing solvent, if used in an amount less than 1 time the weight of the polymer, may not effectively rinse the wet polymer; and, if used in an amount more than 100 times the weight of the polymer, may show a low activity ratio. It is acceptable that the rinsing solvent is directly added to the wet polymer, which has been collected by filtration, in a filtering apparatus such as centrifugal filtering apparatus, or that the wet polymer is once recovered (transferred) into another apparatus and the rinsing solvent is added to the wet polymer in the other apparatus. However, the rinsing solvent is preferably added to the wet polymer in the filtering apparatus (separator) without recovery. After the rinsing solvent is added to the wet polymer, the solvent can be separated and removed by performing pressurization, pressure reduction, or centrifugation.

Though not critical, the amount of solvents contained in the wet polymer upon separation after rinsing is preferably 5 times by weight or less, more preferably 3 times by weight or less, and still more preferably 2 times by weight or less the weight of the polymer to be recovered, in consideration of the amounts of monomers, initiators, polymerization solvents, and formed impurities remaining in the product.

The rinsed resin (wet polymer) contains low-boiling impurities such as the solvent used in the precipitation operation. Such low-boiling impurities, if remained in the films for lithography, may impair the performance of the films and should thereby be removed from the wet polymer. Exemplary techniques for removing the low-boiling impurities include a technique of drying the wet polymer; and a technique of redissolving the wet polymer in a solvent for lithography (lithography solvent) and distilling off the low-boiling impurities from the solution. However, if the low-boiling impurities are removed by the technique of drying the wet polymer, the resulting resin once dried becomes very insoluble in the lithography solvent. This is probably because dried particles of the polymer have strong adhesion with each other. In addition, drying causes another problem in which part of functional groups in the resin undergoes a reaction. Accordingly, it is preferred for obtaining a resin having good solubility that the wet polymer is redissolved in a solvent containing at least one lithography solvent, and the redissolved solution is concentrated to distill off the low-boiling impurities from the wet polymer. In addition, this technique causes less degradation of the resin (polymer) upon removal of the low-boiling impurities.

Polymer solutions for lithography relating to the present invention are each generally prepared by dissolving the above-obtained polymer in a solvent (product solvent). The solvent used herein is chosen as appropriate according to the intended use of the polymer solutions.

When the polymer solutions are used for the formation of resist-protective films, the solvent to be used is not limited, but a solvent that dissolves the resist is undesirable. Examples of such undesirable solvents are solvents generally used as resist solvents, including ketones such as cyclohexanone and methyl-2-n-amyl ketone; alcohols such as 3-methoxybutanol, 3-methyl-3-methoxybutanol, 1-methoxy-2-propanol, and 1-ethoxy-2-propanol; ethers such as propylene glycol monomethyl ether, ethylene glycol monomethyl ether, propylene glycol monoethyl ether, ethylene glycol monoethyl ether, propylene glycol dimethyl ether, and diethylene glycol dimethyl ether; and esters such as propylene glycol monomethyl ether acetate, propylene glycol monoethyl ether acetate, ethyl lactate, ethyl pyruvate, butyl acetate, methyl 3-methoxypropionate, ethyl 3-ethoxypropionate, tert-butyl acetate, tert-butyl propionate, and propylene glycol mono-tert-butyl ether acetate.

Exemplary solvents that do not dissolve the resist layer include higher alcohols having 4 or more carbon atoms; hydrocarbons; chain ethers; and fluorine-containing solvents. Each of such solvents may be used alone or in combination. It is possible to use a solvent having a low polarity in combination with another solvent having a high polarity.

Examples of the alcohols having 4 or more carbon atoms include 1-butyl alcohol, 2-butyl alcohol, isobutyl alcohol, tert-butyl alcohol, 1-pentanol, 2-pentanol, 3-pentanol, tert-amyl alcohol, neopentyl alcohol, 2-methyl-1-butanol, 3-methyl-1-butanol, 3-methyl-3-pentanol, cyclopentanol, 1-hexanol, 2-hexanol, 3-hexanol, 2,3-dimethyl-2-butanol, 3,3-dimethyl-1-butanol, 3,3-dimethyl-2-butanol, 2-diethyl-1-butanol, 2-methyl-1-pentanol, 2-methyl-2-pentanol, 2-methyl-3-pentanol, 3-methyl-1-pentanol, 3-methyl-2-pentanol, 3-methyl-3-pentanol, 4-methyl-1-pentanol, 4-methyl-2-pentanol, 4-methyl-3-pentanol, and cyclohexanol.

Examples of the hydrocarbons include aliphatic hydrocarbons such as hexane, heptane, and octane; alicyclic hydrocarbons such as cyclohexane and methylcyclohexane; and aromatic hydrocarbons such as toluene, xylene, ethylbenzene, and isopropylbenzene.

Exemplary chain ethers include anisole and dibutyl ether.

Examples of the fluorine-containing solvents include 2-fluoroanisole, 3-fluoroanisole, 4-fluoroanisole, 2,3-difluoroanisole, 2,4-difluoroanisole, 2,5-difluoroanisole, 5,8-difluoro-1,4-benzodioxane, 2,3-difluorobenzyl alcohol, 1,3-difluoro-2-propanol, 2″,4″-difluoropropiophenone, 2,4-difluorotoluene, trifluoroacetaldehyde ethyl hemiacetal, trifluoroacetamide, trifluoroethanol, 2,2,2-trifluoroethyl butyrate, ethyl heptafluorobutyrate, ethyl heptafluorobutylacetate, ethyl hexafluoroglutarylmethyl, ethyl 3-hydroxy-4,4,4-trifluorobutyrate, ethyl 2-methyl-4,4,4-trifluoroacetoacetate, ethyl pentafluorobenzoate, ethyl pentafluoropropionate, ethyl pentafluoropropynylacetate, ethyl perfluorooctanoate, ethyl 4,4,4-trifluoroacetoacetate, ethyl 4,4,4-trifluorobutyrate, ethyl 4,4,4-trifluorocrotonate, ethyl trifluorosulfonate, ethyl 3-(trifluoromethyl)butyrate, ethyl trifluoropyruvate, S-ethyl trifluoroacetate, fluorocyclohexane, 2,2,3,3,4,4,4-heptafluoro-1-butanol, 1,1,1,2,2,3,3-heptafluoro-7,7-dimethyl-4,6-octanedione, 1,1,1,3,5,5,5-heptafluoropentane-2,4-dione, 3,3,4,4,5,5,5-heptafluoro-2-pentanol, 3,3,4,4,5,5,5-heptafluoro-2-pentanone, isopropyl 4,4,4-trifluoroacetoacetate, methyl perfluorodenanoate, methyl perfluoro(2-methyl-3-oxahexanoate), methyl perfluorononanoate, methyl perfluorooctanoate, methyl 2,3,3,3-tetrafluoropropionate, methyl trifluoroacetoacetate, 1,1,1,2,2,6,6,6-octafluoro-2,4-hexanedione, 2,2,3,3,4,4,5,5-octafluoro-1-pentanol, 1H,1H,2H,2H-perfluoro-1-decanol, perfluoro(2,5-dimethyl-3,6-dioxane anionic) acid methyl ester, 2H-perfluoro-5-methyl-3,6-dioxanonane, 1H,1H,2H,3H,3H-perfluorononane-1,2-diol, 1H,1H,9H-perfluoro-1-nonanol, 1H,1H-perfluorooctanol, 1H,1H,2H,2H-perfluorooctanol, 2H-perfluoro-5,8,11,14-tetramethyl-3,6,9,12,15-pentaoxaoctadecane, perfluorotributylamine, perfluorotrihexylamine, perfluoro-2,5,8-trimethyl-3,6,9-trioxadodecanoic acid methyl ester, perfluorotripentylamine, perfluorotripropylamine, 1H,1H,2H,3H,3H-perfluoroundecane-1,2-diol, trufluorobutanol 1,1,1-trifluoro-5-methyl-2,4-hexanedione, 1,1,1-trifluoro-2-propanol, 3,3,3-trifluoro-1-propanol, 1,1,1-trifluoro-2-propyl acetate, perfluorobutyltetrahydrofuran, perfluoro(butyltetrahydrofuran), perfluorodecahydronaphthalene, perfluoro(1,2-dimethylcyclohexane), perfluoro(1,3-dimethylcyclohexane), propylene glycol trifluoromethyl ether acetate, propylene glycol methyl ether trifluoromethylacetate, trifluoromethyl butylacetate, methyl 3-trifluoromethoxypropionate, perfluorocyclohexanone, propylene glycol trifluoromethyl ether, butyl trifluoroacetate, 1,1,1-trifluoro-5,5-dimethyl-2,4-hexanedione, 1,1,1,3,3,3-hexafluoro-2-propanol, 1,1,1,3,3,3-hexafluoro-2-methyl-2-propanol, 2,2,3,4,4,4-hexafluoro-1-butanol, 2-trifluoromethyl-2-propanol, 2,2,3,3-tetrafluoro-1-propanol, 3,3,3-trifluoro-1-propanol, and 4,4,4-trifluoro-1-butanol.

Especially preferred solvents as the solvent for use in the polymer solutions for the formation of resist-protective films herein include alcohols having 4 or more carbon atoms, of which aliphatic or alicyclic alcohols having 4 to 6 carbon atoms are preferred; and fluorinated alcohols corresponding to aliphatic or alicyclic alcohols having 2 or more carbon atoms, except with part or all of hydrogen atoms bound to carbon atoms being substituted by fluorine atoms, of which fluorinated alcohols having 4 to 10 carbon atoms are preferred.

Exemplary resist solvents include the glycol solvents, ester solvents, and ketone solvents listed as the polymerization solvent, and solvent mixtures of them. Among them, preferred solvents are propylene glycol monomethyl ether, propylene glycol monomethyl ether acetate, ethyl lactate, methyl isobutyl ketone, methyl amyl ketone, cyclohexanone, and mixtures of these; of which solvents containing at least propylene glycol monomethyl ether acetate are more preferred, and examples thereof include propylene glycol monomethyl ether acetate alone used as a single solvent; a solvent mixture containing propylene glycol monomethyl ether acetate and propylene glycol monomethyl ether; a solvent mixture containing propylene glycol monomethyl ether acetate and ethyl lactate; and a solvent mixture containing propylene glycol monomethyl ether acetate and cyclohexanone.

Exemplary solvents for undercoat films usable herein include alcohol solvents such as methanol, ethanol, propanol, butanol, hexanol, cyclohexanol, octanol, decanol, ethylene glycol, ethylene glycol monomethyl ether, ethylene glycol monoethyl ether, ethylene glycol monoisopropyl ether, diethylene glycol monomethyl ether, diethylene glycol monoethyl ether, propylene glycol, propylene glycol monomethyl ether, propylene glycol monoethyl ether, propylene glycol monopropyl ether, glycerol, glycerol monomethyl ether, glycerol dimethyl ether, glycerol monoethyl ether, and glycerol diethyl ether; and ester solvents such as ethylene glycol monomethyl ether acetate, ethylene glycol monoethyl ether acetate, propylene glycol monomethyl ether acetate, propylene glycol monoethyl ether acetate, methyl lactate, and ethyl lactate.

Each of these solvents can be used alone or in combination as a mixture. Among them, alcohol solvents, and solvent mixtures containing an alcohol solvent in combination with another polar solvent are preferred, because the respective components are satisfactorily soluble in these solvents to give a stable composition.

Of the alcohol solvents, preferred are propylene glycol monomethyl ether, propylene glycol monoethyl ether, and propylene glycol monopropyl ether. Of the solvent mixtures containing an alcohol solvent in combination with another polar solvent, preferred are solvent mixtures containing an alcohol solvent and an ether solvent; and solvent mixtures containing an alcohol solvent and an ester solvent.

Preferred examples of the solvent mixtures containing an alcohol solvent and an ether solvents include solvent mixtures each containing both at least one alcohol solvent selected from the group consisting of propylene glycol monomethyl ether, propylene glycol monoethyl ether, and propylene glycol monopropyl ether, and at least one ether solvent selected from the group consisting of bis(2-methoxyethyl)ether, diethylene glycol diethyl ether, and diethylene glycol methyl ethyl ether.

It is enough that the solvent for redissolution of the wet polymer contains at least one lithography solvent. Specifically, when a solvent mixture containing two different solvents is used as the lithography solvent, the wet polymer may be redissolved in one of the two lithography solvents or in a solvent mixture containing the two lithography solvents. Independently, the wet polymer may be redissolved in at least one of lithography solvents in combination with at least one of other solvents (solvents having boiling points lower than that of the lithography solvent used). Though appropriately chosen according typically to solubility of the resin, the amount of the other solvent than the lithography solvent(s), if used as part of the redissolution solvent, is preferably 20 percent by weight or less, more preferably 10 percent by weight or less, and especially preferably 5 percent by weight or less, based on the total amount of the redissolution solvent, from the viewpoint of energy cost upon concentration. When a solvent mixture containing two different solvents is used as the lithography solvent, a solvent not used for the redissolution of the wet polymer can be added during concentration or after concentration.

The dissolution of the wet polymer in the lithography solvent is preferably performed so that the resulting solution has a solids concentration lower than the solids concentration of the final product. Low-boiling impurities can be removed from the wet polymer by concentrating the solution having a solids concentration lower than that of the final product to a solids concentration higher than that of the final product. Specifically, the dissolution of the wet polymer in the lithography solvent is performed to give a solution having a product concentration (polymer concentration) lower than that of the final product by preferably 2 percent by weight or more and more preferably 5 percent by weight or more.

Distillation of the redissolved solution thus prepared is preferably performed by circulating a heat transfer medium or steam at 140° C. or below through a heating jacket and/or tube (e.g., coiled tube) of a still. Exemplary distillation columns usable herein include customary distillation columns such as single distillation columns, plate columns, and packed columns. The polymer can be significantly prevented from thermal denaturation (thermal degradation) by setting the temperature of the heat transfer medium and/or steam (preferably the temperatures of both the heat transfer medium and steam when used in combination) to 140° C. or below. The temperature of the heat transfer medium and/or steam is preferably 130° C. or below, more preferably 120° C. or below, and especially preferably 110° C. or below. The lower limit of the temperature is typically about 40° C., and preferably about 50° C. When a heat transfer medium or steam at a temperature above 140° C. is circulated through the heating jacket or tube, the polymer may decompose on the wall surface of the heating jacket or tube even when the liquid temperature in the still is set to be low. When a heat transfer medium or steam having a temperature of below 40° C. is used for heating, the degree of pressure reduction (decompression) should be significantly low, this may make the cooling water for cooling and condensing the distilled solvent be excessively low in temperature and may invite disadvantages in cost.

Agitation of the solution in the still with an agitator is preferably performed during the distillation. The agitation during distillation is further effective particularly when the solution has an increased viscosity, i.e., when the dissolved resin has an increased concentration. This is probably because the agitation enables smooth replacement of the solution on the surface of the jacket or coil (tube) to thereby prevent superheating of the solution. The intensity of the agitation is not critical, as long as the solution inside can be agitated and blended.

Tough varying depending typically on the type of the redissolution solvent, distillation is performed at a pressure of generally 500 to 1 torr (66.5 to 0.133 kPa) and preferably 400 to 2 torr (53.2 to 0.266 kPa). Distillation, if performed under an excessively high pressure, causes an excessively high distillation temperature, and this may cause pyrolysis of the resin. In contrast, distillation, if performed under an excessively low pressure, may require the coolant for use in concentration of the evaporated solvent to have a lower temperature, thus being uneconomical. The liquid temperature in the still (still liquid temperature) is preferably 100° C. or below and more preferably 80° C. or below.

Distillation is performed so that not only low-boiling impurities but also part of the lithography solvent (when another solvent is used in addition to the lithography solvent, part of the lithography solvent and of the other solvent) are distilled off, to thereby remove the low-boiling impurities completely. Though chosen according typically to the content of low-boiling impurities in the wet polymer, and the type and composition of the redissolution solvent, the distillation percentage or distillation rate [(amount of distillate)/(amount of charge)×100 (percent by weight)] is generally about 30 to 90 percent by weight and preferably about 50 to 87 percent by weight.

The polymer solution finally concentrated by distillation has a polymer concentration of typically about 10 to 70 percent by weight, preferably about 20 to 60 percent by weight, and especially preferably about 30 to 50 percent by weight.

After removing low-boiling impurities by distillation, a polymer solution having a desired concentration is prepared, where necessary, by adding another portion of the lithography solvent to the residual solution. The resulting final polymer solution has a polymer concentration of, for example, 5 to 50 percent by weight and preferably 10 to 30 percent by weight.

The resulting polymer solution for lithography has a content of the polymerization solvent of preferably 1 percent by weight or less, and more preferably 0.5 percent by weight or less, relative to the weight of solids content. A polymer solution for lithography, if having a polymerization solvent content of more than 1 percent by weight, may fail to give a uniform film, because of causing foaming during film formation or causing dissolution of an underlying film.

The polymer solutions for lithography relating to the present invention may further contain appropriate additives according to necessity.

Typically, polymer solutions for resist may further contain, for example, one or more of a light-activatable acid generator, a dissolution inhibitor, a basic compound, and a surfactant.

The light-activatable acid generator is preferably one that generates an acid by the action of light having a wavelength of 300 nm or less, and preferably 220 nm or less, and any light-activatable acid generator will do, as long as a mixture thereof with the polymer according to the present invention and other components is sufficiently soluble in an organic solvent to give a solution, and the solution can give a uniform coated film by a film forming technique such as spin coating. Each of different light-activatable acid generators may be used alone or in combination with each other, or in combination with one or more appropriate sensitizers.

Exemplary light-activatable acid generators usable herein include light-activatable acid generators such as triphenylsulfonium salt derivatives described by J. V. Crivello et al. in Journal of the Organic Chemistry, Vol. 43, No. 15, pages 3055-3058 (1978), other onium salts represented by them (e.g., compounds such as sulfonium salts, iodonium salts, phosphonium salts, diazonium salts, and ammonium salts); 2,6-dinitrobenzyl esters [O. Nalamasu et al., Proceedings of SPIE, Vol. 1262, page 32 (1990)], and 1,2,3-tri(methanesulfonyloxy)benzene [Takumi Ueno et al., Proceedings of PME '89, Kodansha Ltd., pages 413-424 (1990)].

Specific examples of light-activatable acid generators include, but are not limited to, cyclohexylmethyl(2-oxocyclohexyl)sulfonium trifluoromethanesulfonate, dicyclohexyl(2-oxocyclohexyl)sulfonium trifluoromethanesulfonate, 2-dicyclohexylsulfonylcyclohexanone, dimethyl(2-oxocyclohexyl)sulfonium trifluoromethanesulfonate, triphenylsulfonium trifluoromethanesulfonate, diphenyliodonium trifluoromethanesulfonate, and N-hydroxysuccinimide trifluoromethanesulfonate.

In the compositions according to the present invention, each of different light-activatable acid generators may be used alone or in combination. The content of light-activatable acid generators is generally 0.02 to 5 parts by weight and preferably 0.05 to 3 parts by weight, per 100 parts by weight of the total components including the light-activatable acid generators themselves.

The polymer solutions for undercoat films may further contain any of crosslinking agents, adhesive aids, rheology modifiers, surfactants, light-activatable acid generators, and heat-activatable acid generators, according to necessity.

The rheology modifiers are added mainly for the purpose of improving flowability of the compositions for the formation of anti-reflection coatings to allow the compositions for the formation of anti-reflection coatings to be satisfactorily charged particularly in holes in a firing step.

Specific examples of the rheology modifiers include phthalic acid derivatives such as dimethyl phthalate, diethyl phthalate, diisobutyl phthalate, dihexyl phthalate, and butyl isodecyl phthalate; adipic acid derivatives such as di-n-butyl adipate, diisobutyl adipate, diisooctyl adipate, and octyl decyl adipate; maleic acid derivatives such as di-n-butyl maleate, diethyl maleate, and dinonyl maleate; oleic acid derivatives such as methyl oleate, butyl oleate, and tetrahydrofurfuryl oleate; and stearic acid derivatives such as and n-butyl stearate and glyceryl stearate. These rheology modifiers are added generally in an amount of less than 30 percent by weight based on the total amount of the composition for anti-reflection coatings.

The surfactants are added for the inhibition of occurrence of pinholes or striation, to allow the composition to be coated more satisfactorily without surface roughness. Examples of the surfactants include nonionic surfactants, fluorochemical surfactants, and organosiloxane polymers. The amount of the surfactants is generally 0.2 percent by weight or less and preferably 0.1 percent by weight or less based on the total weight of the composition for the formation of anti-reflection coatings according to the present invention. Each of different surfactants may be used alone or in combination.

The polymer solutions for the formation of topcoats may further contain other components such as surfactants and light-activatable acid generators according to necessity.

### EXAMPLES

The present invention will be illustrated in further detail with reference to several working examples below. It should be noted, however, that these examples are never construed to limit the scope of the present invention. A polymer concentration was determined by placing 1 g of a sample polymer solution on an evaporating dish, drying the sample at 160° C. under reduced pressure, and measuring the weight of the residue to determine the polymer concentration.

The weight-average molecular weight (Mw) and molecular weight distribution (Mw/Mn) of a sample polymer were determined by measuring the weight-average molecular weight (Mw) and a number-average molecular weight (Mn) in terms of standard polystyrene through gel permeation chromatography (GPC) using a refractive index detector (RI) as a detector and tetrahydrofuran (THF) as an eluent. The measurement through GPC was performed by using three columns [Shodex KF-806L] (trade name) supplied by Showa Denko K.K. connected in series under conditions of a sample concentration of 0.5 percent by weight, an amount of injected sample of 35 μl, a column temperature of 40° C., an RI temperature of 40° C., an eluent flow rate of 0.8 ml/min., and an analysis time of 60 minutes. The GPC system used herein was [LC-10A] supplied by Shimadzu Corporation.

Monomers used are indicated hereinbelow by the following abbreviated names: benzyl methacrylate (BzMA), 2-hydroxyethyl methacrylate (HEMA), 5-methacryloyloxy-2,6-norbornylcarbolactone (MNBL), 1H,1H,5H-octafluoropentyl methacrylate (OFPMA), and methacrylic acid (MAA).

### Example 1

In a nitrogen atmosphere, 51.0 g of cyclohexanone (CHO, coefficient of viscosity at 20° C.: 2.01 mPa·s) was placed in a 500-ml round-bottomed flask equipped with a reflux condenser, a stirring bar, and a three-way stopcock; and a monomer solution was added dropwise thereto at a constant rate over 5 hours while stirring and holding the temperature to 75° C., which monomer solution had been prepared by mixing 9.9 g (56.2 mmol) of BzMA, 3.6 g (27.7 mmol) of HEMA, 16.5 g (74.2 mmol) of MNBL, 0.60 g of an initiator (supplied by Wako Pure Chemical Industries Ltd. under the trade name “AIBN”), and 119 g of CHO. After the completion of dropwise addition, the mixture was stirred for further 2 hours. After the completion of polymerization reaction, the resulting reaction solution was diluted with 50 g of tetrahydrofuran (THF, coefficient of viscosity at 20° C.: 0.49 mPa·s) to give a uniform solution having a concentration of charged monomers of 12 percent by weight. The diluted reaction solution was added dropwise to 1400 g of a 8:2 (by weight) mixture of heptane and ethyl acetate with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 25.5 g of the target resin (polymer). The recovered polymer was analyzed through gel permeation chromatography (GPC) and found to have a weight-average molecular weight (Mw) of 20400 and a molecular weight distribution (Mw/Mn) of 2.0. The polymer was further analyzed on contents of residual monomers through liquid chromatography and found to have a BzMA content of 0.03 (percent by weight), a HEMA content of N.D. (not detected), and a MNBL content of 0.17 (percent by weight).

### Example 2

In a nitrogen atmosphere, 36 g of CHO was placed in a 500-ml round-bottomed flask equipped with a reflux condenser, a stirring bar, and a three-way stopcock; and a monomer solution was added dropwise thereto at a constant rate over 5 hours while stirring and holding the temperature to 75° C., which monomer solution had been prepared by mixing 9.9 g (56.2 mmol) of BzMA, 3.6 g (27.7 mmol) of HEMA, 16.5 g (74.2 mmol) of MNBL, 1.9 g of the initiator “AIBN”, and 84 g of CHO. After the completion of dropwise addition, the mixture was stirred for further 2 hours. After the completion of polymerization reaction, the resulting reaction solution was diluted with 150 g of methyl isobutyl ketone (MIBK, coefficient of viscosity at 20° C.: 0.61 mPa·s) to give a uniform solution having a concentration of charged monomers of 10 percent by weight. The diluted reaction solution was added dropwise to 1400 g of a 8:2 (by weight) mixture of heptane and ethyl acetate with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 27.0 g of the target resin (polymer). The recovered polymer was analyzed through gel permeation chromatography (GPC) and found to have a weight-average molecular weight (Mw) of 22300 and a molecular weight distribution (Mw/Mn) of 2.0. The polymer was further analyzed on contents of residual monomers through liquid chromatography and found to have a BzMA content of 0.03 (percent by weight), a HEMA content of N.D., and a MNBL content of 0.16 (percent by weight).

### Example 3

In a nitrogen atmosphere, 41.0 g of CHO was placed in a 500-ml round-bottomed flask equipped with a reflux condenser, a stirring bar, and a three-way stopcock; and a monomer solution was added dropwise thereto at a constant rate over 5 hours while stirring and holding the temperature to 75° C., which monomer solution had been prepared by mixing 9.9 g (56.2 mmol) of BzMA, 3.6 g (27.7 mmol) of HEMA, 16.5 g (74.2 mmol) of MNBL, 1.5 g of the initiator “AIBN”, and 95.7 g of CHO. After the completion of dropwise addition, the mixture was stirred for further 2 hours. After the completion of polymerization reaction, the resulting reaction solution was diluted with 106 g of CHO to give a uniform solution having a concentration of charged monomers of 11 percent by weight. The diluted reaction solution was added dropwise to 1400 g of a 8:2 (by weight) mixture of heptane and ethyl acetate with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 26.4 g of the target resin (polymer). The recovered polymer was analyzed through gel permeation chromatography (GPC) and found to have a weight-average molecular weight (Mw) of 20400 and a molecular weight distribution (Mw/Mn) of 2.0. The polymer was further analyzed on contents of residual monomers through liquid chromatography and found to have a BzMA content of 0.05 (percent by weight), a HEMA content of 0.02 (percent by weight), and a MNBL content of 0.40 (percent by weight).

### Example 4

In a nitrogen atmosphere, 51 g of propylene glycol monomethyl ether (PGME, coefficient of viscosity at 20° C.: 1.81 mPa·s) was placed in a 500-ml round-bottomed flask equipped with a reflux condenser, a stirring bar, and a three-way stopcock; and a monomer solution was added dropwise thereto at a constant rate over 5 hours while stirring and holding the temperature to 75° C., which monomer solution had been prepared by mixing 9.9 g (56.2 mmol) of BzMA, 3.6 g (27.7 mmol) of HEMA, 16.5 g (74.2 mmol) of MNBL, 0.5 g of the initiator “AIBN”, and 119 g of PGME. After the completion of dropwise addition, the mixture was stirred for further 2 hours. After the completion of polymerization reaction, the resulting reaction solution was diluted with 50 g of THF to give a uniform solution having a concentration of charged monomers of 12 percent by weight. The diluted reaction solution was added dropwise to 1400 g of a 8:2 (by weight) mixture of heptane and ethyl acetate with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 25.2 g of the target resin (polymer). The recovered polymer was analyzed through gel permeation chromatography (GPC) and found to have a weight-average molecular weight (Mw) of 18000 and a molecular weight distribution (Mw/Mn) of 2.0. The polymer was further analyzed on contents of residual monomers through liquid chromatography and found to have a BzMA content of 0.03 (percent by weight), a HEMA content of N.D., and a MNBL content of 0.16 (percent by weight).

### Example 5

In a nitrogen atmosphere, 73.1 g of propylene glycol monomethyl ether acetate (PGMEA, coefficient of viscosity at 20° C.: 1.30 mPa·s) was placed in a 500-ml round-bottomed flask equipped with a reflux condenser, a stirring bar, and a three-way stopcock; and a monomer solution was added dropwise thereto at a constant rate over 5 hours while stirring and holding the temperature to 80° C., which monomer solution had been prepared by mixing 21.6 g (72.0 mmol) of OFPMA, 5.4 g (62.8 mmol) of MAA, 3.0 g (13.5 mmol) of MNBL, 2.4 g of an initiator dimethyl 2,2′-azobis(2-methylpropionate) (supplied by Wako Pure Chemical Industries Ltd. under the trade name “V-601”), and 96.9 g of PGMEA. After the completion of dropwise addition, the mixture was stirred for further 2 hours. After the completion of polymerization reaction, the resulting reaction solution was diluted with 50 g of tetrahydrofuran (THF, coefficient of viscosity at 20° C.: 0.49 mPa·s) to give a uniform solution having a concentration of charged monomers of 12 percent by weight. The diluted reaction solution was added dropwise to 1600 g of a 8:2 (by weight) mixture of heptane and ethyl acetate with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 27.0 g of the target resin (polymer). The recovered polymer was analyzed through gel permeation chromatography (GPC) and found to have a weight-average molecular weight (Mw) of 10200 and a molecular weight distribution (Mw/Mn) of 1.9. The polymer was further analyzed on contents of residual monomers through liquid chromatography and found to have an OFPMA content of N.D., a MAA content of 0.05 (percent by weight), and a MNBL content of 0.13 (percent by weight).

### Example 6

In a nitrogen atmosphere, 73.1 g of PGMEA was placed in a 500-ml round-bottomed flask equipped with a reflux condenser, a stirring bar, and a three-way stopcock; and a monomer solution was added dropwise thereto at a constant rate over 5 hours while stirring and holding the temperature to 80° C., which monomer solution had been prepared by mixing 24.0 g (80.0 mmol) of OFPMA, 6.0 g (69.8 mmol) of MAA, 2.4 g of the initiator “V-601”, and 96.9 g of PGMEA. After the completion of dropwise addition, the mixture was stirred for further 2 hours. After the completion of polymerization reaction, the resulting reaction solution was diluted with 50 g of PGMEA to give a uniform solution having a concentration of charged monomers of 12 percent by weight. The diluted reaction solution was added dropwise to 1600 g of heptane with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 26.4 g of the target resin (polymer). The recovered polymer was analyzed through gel permeation chromatography (GPC) and found to have a weight-average molecular weight (Mw) of 9800 and a molecular weight distribution (Mw/Mn) of 1.9. The polymer was further analyzed on contents of residual monomers through liquid chromatography and found to have an OFPMA content of N.D., and a MAA content of 0.10 (percent by weight).

### Example 7

In a nitrogen atmosphere, 73.1 g of CHO was placed in a 500-ml round-bottomed flask equipped with a reflux condenser, a stirring bar, and a three-way stopcock; and a monomer solution was added dropwise thereto at a constant rate over 5 hours while stirring and holding the temperature to 80° C., which monomer solution had been prepared by mixing 24.0 g (80.0 mmol) of OFPMA, 6.0 g (69.8 mmol) of MAA, 2.4 g of the initiator “V-601”, and 96.9 g of PGMEA. After the completion of dropwise addition, the mixture was stirred for further 2 hours. After the completion of polymerization reaction, the resulting reaction solution was diluted with 50 g of THF to give a uniform solution having a concentration of charged monomers of 12 percent by weight. The diluted reaction solution was added dropwise to 1600 g of heptane with stirring. During dropwise addition, a polymer precipitated as clear powder (particles), and the precipitated polymer was left stand for 24 hours after the completion of stirring, showing no problem such as aggregation of particles. The precipitates were collected by filtration, dried at 25° C. under reduced pressure, and thereby yielded 26.7 g of the target resin (polymer). The recovered polymer was analyzed through gel permeation chromatography (CPC) and found to have a weight-average molecular weight (Mw) of 10000 and a molecular weight distribution (Mw/Mn) of 1.8. The polymer was further analyzed on contents of residual monomers through liquid chromatography and found to have an OFPMA content of N.D., and a MAA content of 0.04 (percent by weight).

### Comparative Example 1

A polymer was produced by the procedure of Example 1, except for not diluting the reaction solution after polymerization with a solvent. The undiluted reaction solution had a monomer concentration of 15 percent by weight. The undiluted reaction solution was added dropwise to 1400 g of a 8:2 (by weight) mixture of heptane and ethyl acetate with stirring. During dropwise addition, a polymer precipitated as large particles and rapidly settled. The settled polymer was left stand for 24 hours to show aggregation of particles. The precipitates were collected by filtration, dried at 25° C. under reduced pressure, and thereby yielded 26.0 g of a resin (polymer). The recovered polymer was analyzed through gel permeation chromatography (GPC) and found to have a weight-average molecular weight (Mw) of 19800 and a molecular weight distribution (Mw/Mn) of 2.2. The polymer was further analyzed on contents of residual monomers through liquid chromatography and found to have a BzMA content of 0.31 (percent by weight), a HEMA content of 0.12 (percent by weight), and a MNBL content of 0.82 (percent by weight).

### Comparative Example 2

A polymer was produced by the procedure of Example 5, except for not diluting the reaction solution after polymerization with a solvent. The undiluted reaction solution had a monomer concentration of 15 percent by weight. The undiluted reaction solution was added dropwise to 1600 g of a 8:2 (by weight) mixture of heptane and ethyl acetate with stirring. During dropwise addition, a polymer precipitated as large particles and rapidly settled. The settled polymer was left stand for 24 hours to show aggregation of particles. The precipitates were collected by filtration, dried at 25° C. under reduced pressure, and thereby yielded 27.2 g of a resin (polymer). The recovered polymer was analyzed through gel permeation chromatography (GPC) and found to have a weight-average molecular weight (Mw) of 10000 and a molecular weight distribution (Mw/Mn) of 2.0. The polymer was further analyzed on contents of residual monomers through liquid chromatography and found to have an OFPMA content of 0.12 (percent by weight), a MAA content of 0.34 (percent by weight), and a MNBL content of 0.60 (percent by weight).

### Comparative Example 3

A polymer was produced by the procedure of Example 6, except for not diluting the reaction solution after polymerization with a solvent. The undiluted reaction solution had a monomer concentration of 15 percent by weight. The undiluted reaction solution was added dropwise to 1600 g of heptane with stirring. During dropwise addition, a polymer precipitated as large particles and rapidly settled. The settled polymer was left stand for 24 hours to show aggregation of particles. The precipitates were collected by filtration, dried at 25° C. under reduced pressure, and thereby yielded 26.5 g of a resin. The recovered polymer was analyzed through gel permeation chromatography (GPC) and found to have a weight-average molecular weight (Mw) of 9500 and a molecular weight distribution (Mw/Mn) of 2.1. The polymer was further analyzed on contents of residual monomers through liquid chromatography and found to have an OFPMA content of 0.08 (percent by weight) and a MAA content of 0.35 (percent by weight).

### Comparative Example 4

A polymer was produced by the procedure of Example 7, except for not diluting the reaction solution after polymerization with a solvent. The undiluted reaction solution had a monomer concentration of 15 percent by weight. The undiluted reaction solution was added dropwise to 1600 g of heptane with stirring. During dropwise addition, a polymer precipitated as large particles and rapidly settled. The settled polymer was left stand for 24 hours to show aggregation of particles. The precipitates were collected by filtration, dried at 25° C. under reduced pressure, and thereby yielded 26.8 g of a resin (polymer). The recovered polymer was analyzed through gel permeation chromatography (GPC) and found to have a weight-average molecular weight (Mw) of 9600 and a molecular weight distribution (Mw/Mn) of 2.0. The polymer was further analyzed on contents of residual monomers through liquid chromatography and found to have an OFPMA content of 0.06 (percent by weight) and a MAA content of 0.42 (percent by weight).

### INDUSTRIAL APPLICABILITY

The process according to the present invention can reduce, by a simple procedure, the amounts of residual low-molecular-weight components such as monomers used in polymerization. The process gives polymers which are usable as polymers for the formation of coated films to be adopted to semiconductor lithography, such as resist polymers, polymers for anti-reflection coatings, polymers for undercoat films of multilayer resists, and polymers for immersion topcoat films.

1. A process for the production of a polymer, the process comprising the steps of reacting or polymerizing a monomer or monomers in a solvent to give a polymer solution; and bringing the polymer solution into contact with a poor solvent to precipitate the polymer and to remove impurities therefrom, wherein the polymer solution is combined with and diluted with a solvent before being brought into contact with the poor solvent to precipitate the polymer.

2. The process for the production of a polymer, according to claim 1, wherein the solvent for use in the polymerization has a coefficient of viscosity at 20° C. of 1 mPa·s or more.

3. The process for the production of a polymer, according to claim 1, wherein the solvent for use in the dilution has a coefficient of viscosity at 20° C. of less than 1 mPa·s.

4. The process for the production of a polymer, according to claim 1, wherein the poor solvent for use in the precipitation comprises a hydrocarbon compound.
